(19) United States
(12) Patent Application Publication
(10) Pub. No.: US 2023/0237943 A1
(43) Pub. Date: Jul. 27, 2023

(54) DISPLAY DEVICE AND DISPLAY METHOD

(71) Applicant: NIPPON TELEGRAPH AND TELEPHONE CORPORATION, Chiyoda-ku, Tokyo (JP)

(72) Inventors: Munekazu DATE, Musashino-shi, Tokyo (JP); Shinya SHIMIZU, Musashino-shi, Tokyo (JP); Takasuke NAGAI, Musashino-shi, Tokyo (JP); Dan MIKAMI, Musashino-shi, Tokyo (JP); Yoshinori KUSACHI, Musashino-shi, Tokyo (JP)

(73) Assignee: NIPPON TELEGRAPH AND TELEPHONE CORPORATION, Chiyoda-ku, Tokyo (JP)

(21) Appl. No.: 17/905,333

(22) PCT Filed: Mar. 6, 2020
(86) PCT No.: PCT/JP2020/009860

§ 371 Date: Feb. 6, 2023

(51) Int. Cl. G09G 3/00

(52) U.S. Cl. CPC G09G 3/007; G09G 2300/0452; G09G 2320/0261

(57) ABSTRACT

An image display device (1) according to the present disclosure includes an image display unit (2) that has a pixel structure of subpixels having a plurality of colors, in which the subpixels having different colors are aligned in a first direction, and the subpixels having the same color are aligned in a second direction perpendicular to the first direction and causes an observer ob to observe an image through a plurality of opening portions (24) disposed for each pixel block BL including a plurality of pixels including the subpixels having the plurality of colors. A width of each of the plurality of opening portions (24) in the first direction is substantially equal to a width of a subpixel of the subpixels in the first direction, and the plurality of opening portions (24) are disposed to be shifted in the first direction.

### TECHNICAL FIELD

The present disclosure relates to a display device and a display method.

### BACKGROUND ART

To express the high sense of realism in a display device, smooth reproduction of motion parallax (change in visibility in accordance with an observation position) is important. For an expression format capable of expressing the motion parallax, a multi-view display format is provided. Unfortunately, the multi-view display format causes switching of a viewing region. Other expression formats capable of expressing the motion parallax include an ultra-multi-eye display format or a high-density directivity display format having improved directivity density of the multi-eye display format. Unfortunately, these expression formats cause the enormous amount of data to be provided to the display device.

PTL 1 and PTL 2 disclose a technique of presenting continuous motion parallax with a small number of images by performing linear blending for smoothly changing a ratio of luminance of a plurality of images with movement of an observation position.

PTL 3 discloses a technique of reproducing continuous motion parallax with a small device by combining a liquid crystal panel including a plurality of pixels including subpixels having a plurality of colors and an optical barrier that is disposed on a front surface of the liquid crystal panel and includes a plurality of opening portions.

### CITATION LIST

### Patent Literature

PTL 1: JP 2015-121748 A

PTL 2: JP 2016-161912 A

PTL 3: JP 2018-180508 A

### SUMMARY OF THE INVENTION

### Technical Problem

In the technique disclosed in PTL 3, the liquid crystal panel is configured such that a plurality of subpixels of the same color are aligned in a horizontal direction (lateral direction on paper), and the horizontal width of each subpixel is equal to the horizontal width of the pixel. The optical barrier extends in a perpendicular direction (longitudinal direction on paper), and opening portions having a horizontal width which is substantially equivalent to (substantially equal to) a horizontal width of the pixel are disposed at a predetermined pitch in the horizontal direction. In the technique disclosed in PTL 3, the motion parallax is reproduced at a plurality of observation positions in the horizontal direction by using a point that the pixel observed through the opening portion changes with movement of the observation position in the horizontal direction. That is, the technique disclosed in PTL 3 allows an image in which the motion parallax is reproduced (an image corresponding to the observation position) to be observed every time the observation position moves to the horizontal position by the amount that the pixel observed through the opening portion is shifted by one pixel.

As described above, in order to observe an image in which the motion parallax is reproduced, it is necessary for the technique disclosed in PTL 3 not to generate the motion parallax in the perpendicular direction of the observation position but to move the observation position in the horizontal direction by the amount that the pixel observed through the opening portion is shifted by one pixel. Thus, increasing, by using the technique disclosed in PTL 3, the number of viewpoints from which an image in which the motion parallax is reproduced can be observed depends only on the number of pixels in the horizontal direction has an influence on the number of viewpoints, and thus, increasing the number of viewpoints causes only the resolution in the horizontal direction to be lowered in comparison to the resolution in the perpendicular direction, limiting the increase of the number of viewpoints.

The present disclosure has been made in view of the above issues, and an object of the present disclosure is to provide a display device and a display method capable of expressing a high sense of realism by increasing the number of viewpoints from which an image in which motion parallax is reproduced can be observed.

### Means for Solving the Problem

To solve the above issue, a display device according to the present disclosure includes an image display unit that has a pixel structure of subpixels having a plurality of colors, in which the subpixels having different colors are aligned in a first direction, and the subpixels having the same color are aligned in a second direction perpendicular to the first direction and causes an observer to observe an image through a plurality of opening portions disposed for an individual pixel block including a plurality of pixels including the subpixels having the plurality of colors. A width of each of the plurality of opening portions in the first direction is substantially equal to a width of a subpixel of the subpixels in the first direction, and the plurality of opening portions are disposed to be shifted in the first direction.

To solve the above issue, a display device according to the present disclosure includes an image display unit that has a pixel structure in which subpixels having a plurality of colors are aligned so that the colors of the subpixels adjacent to each other in a first direction and a second direction perpendicular to the first direction are different from each other and causes an observer to observe an image through a plurality of opening portions disposed for each pixel block including a plurality of pixels configured by the subpixels having the plurality of colors. A width of each of the plurality of opening portions in the first direction is substantially equal to a width of the subpixel in the first direction, and the plurality of opening portions are disposed at the same position in the first direction.

To solve the above issue, a display method according to the present disclosure is a display method in a display device including an image display unit that has a pixel structure of subpixels having a plurality of colors, in which the subpixels having different colors are aligned in a first direction, and the subpixels having the same color are aligned in a second direction perpendicular to the first direction, and causes an observer to observe an image through a plurality of opening portions disposed for each pixel block including a plurality of pixels including the subpixels having the plurality of colors. A width of each of the plurality of opening portions in the first direction is substantially equal to a width of a subpixel of the subpixels in the first direction, and the plurality of opening portions are disposed to be shifted in the first direction. The display method includes controlling display of the subpixels observed when viewed from a predetermined observation position through the opening portion in accordance with an image from the predetermined observation position.

### Effects of the Invention

According to the display device and the display method of the present disclosure, it is possible to increase the number of viewpoints from which an image in which motion parallax is reproduced can be observed, in the first direction, and to make an expression with a high sense of realism.

### BRIEF DESCRIPTION OF DRAWINGS

FIG. 1 is a diagram illustrating a schematic configuration of a display device according to an embodiment of the present disclosure.

FIG. 2A is a diagram illustrating an example of a configuration of an image display unit illustrated in FIG. 1.

FIG. 2B is a diagram illustrating another example of the configuration of the image display unit illustrated in FIG. 1.

FIG. 3 is a diagram illustrating a pixel configuration of the image display unit illustrated in FIG. 1.

FIG. 4 is a diagram illustrating an example of a positional relation between the pixel configuration of the image display unit illustrated in FIG. 3 and an opening portion provided in a barrier.

FIG. 5 is a diagram for explaining a principle of linear blending in the display device illustrated in FIG. 1.

FIG. 6 is a diagram illustrating a change in a mixing ratio when the opening portion apparently moves in a first direction from the state illustrated in FIG. 5.

FIG. 7 is a diagram for explaining an “observation range” in the present disclosure.

FIG. 8 is a diagram for explaining a “viewing region” in the present disclosure.

FIG. 9A is a diagram for explaining a “viewpoint” in the present disclosure.

FIG. 9B is a diagram for explaining the “viewpoint” in the present disclosure.

FIG. 9C is a diagram for explaining the “viewpoint” in the present disclosure.

FIG. 10A is a diagram for explaining adjustment of a viewing distance by enlargement/reduction of a barrier in the display device illustrated in FIG. 1.

FIG. 10B is a diagram for explaining the adjustment of the viewing distance by enlargement/reduction of the barrier in the display device illustrated in FIG. 1.

FIG. 11 is a diagram for explaining a display method in the display device illustrated in FIG. 1.

FIG. 12 is a diagram for explaining an example of a method of capturing an image displayed on the display device illustrated in FIG. 1.

FIG. 13 is a diagram illustrating a relation between a weighted average of two images and a contour position.

FIG. 14 is a diagram illustrating another example of the positional relation between the pixel configuration of the image display unit illustrated in FIG. 3 and the opening portion provided in the barrier.

FIG. 15 is a diagram for explaining a display method in a display device including the image display unit illustrated in FIG. 14.

FIG. 16 is a diagram illustrating still another example of the positional relation between the pixel configuration of the image display unit illustrated in FIG. 3 and the opening portion provided in the barrier.

FIG. 17 is a diagram for explaining a display method in a display device including the image display unit illustrated in FIG. 16.

FIG. 18 is a diagram illustrating still another example of the positional relation between the pixel configuration of the image display unit illustrated in FIG. 3 and the opening portion provided in the barrier.

FIG. 19 is a diagram illustrating still another example of the positional relation between the pixel configuration of the image display unit illustrated in FIG. 3 and the opening portion provided in the barrier.

FIG. 20 is a diagram illustrating still another example of the positional relation between the pixel configuration of the image display unit illustrated in FIG. 3 and the opening portion provided in the barrier.

FIG. 21 is a diagram illustrating another example of the positional relation between the pixel configuration of the image display unit illustrated in FIG. 1 and the opening portion provided in the barrier.

FIG. 22 is a diagram for explaining a display method in a display device including the image display unit illustrated in FIG. 21.

FIG. 23A is a diagram illustrating another example of a shape of the opening portion illustrated in FIG. 4.

FIG. 23B is a diagram illustrating still another example of the shape of the opening portion illustrated in FIG. 4.

FIG. 23C is a diagram illustrating still another example of the shape of the opening portion illustrated in FIG. 4.

FIG. 23D is a diagram illustrating still another example of the shape of the opening portion illustrated in FIG. 4.

FIG. 24A is a diagram illustrating another example of shapes of the pixel and the opening portion illustrated in FIG. 4.

FIG. 24B is a diagram illustrating still another example of the shapes of the pixel and the opening portion illustrated in FIG. 4.

FIG. 24C is a diagram illustrating still another example of the shapes of the pixel and the opening portion illustrated in FIG. 4.

FIG. 24D is a diagram illustrating still another example of the shapes of the pixel and the opening portion illustrated in FIG. 4.

FIG. 24E is a diagram illustrating still another example of the shapes of the pixel and the opening portion illustrated in FIG. 4.

FIG. 25 is a diagram illustrating still another example of the positional relation between the pixel configuration of the image display unit illustrated in FIG. 1 and the opening portion provided in the barrier.

### DESCRIPTION OF EMBODIMENTS

Hereinafter, an embodiment of the present disclosure will be described with reference to the drawings.

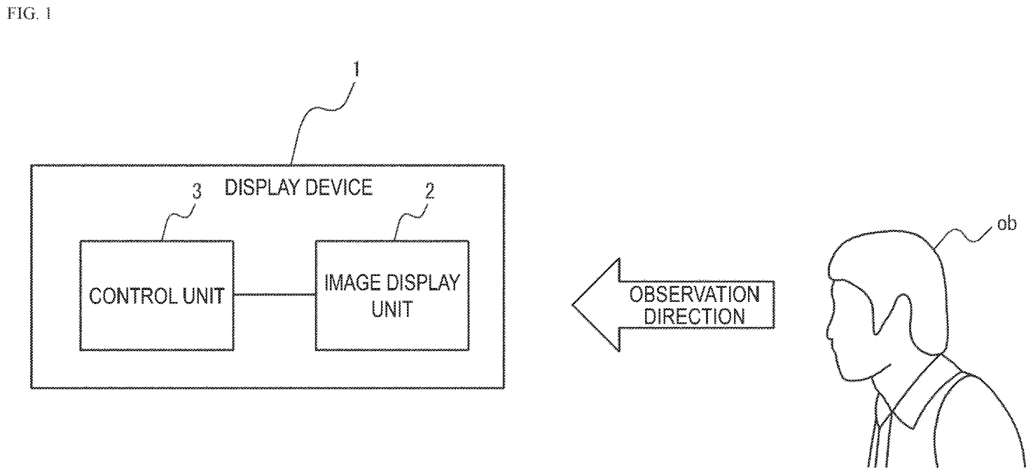

FIG. 1 is a schematic diagram illustrating a configuration of a display device 1 according to an embodiment of the present disclosure. The display device 1 according to the present embodiment causes an observer ob to observe an image corresponding to a change in an observation direction of the observer ob.

The display device 1 illustrated in FIG. 1 includes an image display unit 2 and a control unit 3 that controls display of the image display unit 2.

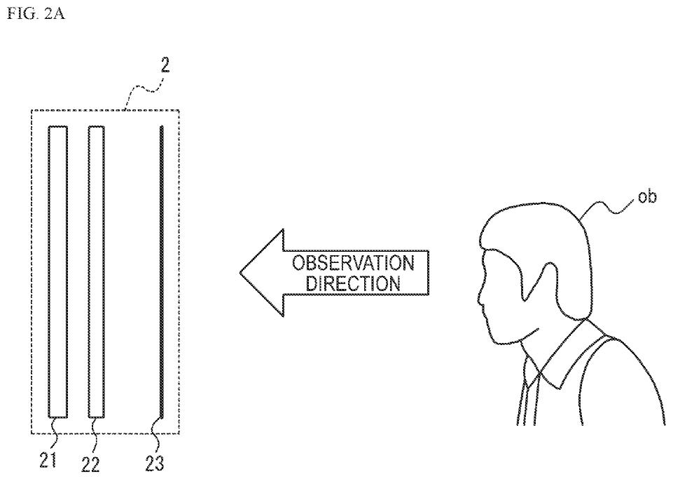

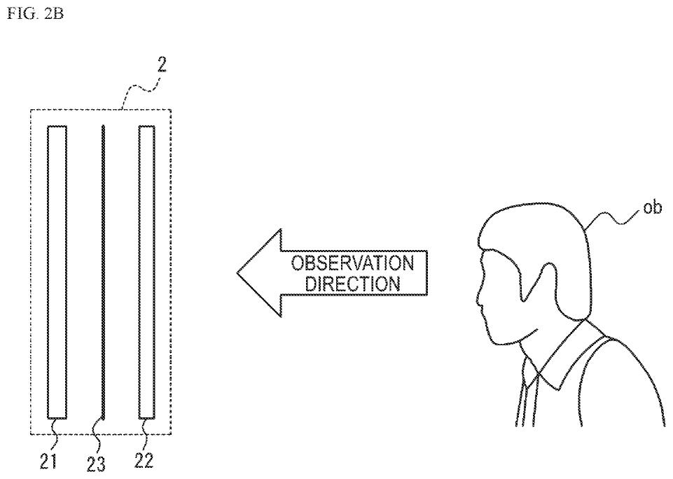

The image display unit 2 has a stripe configuration in which subpixels having the same color among subpixels having a plurality of colors are aligned in a predetermined direction. The image display unit 2 causes the observer ob to observe an image configured by pixels including the subpixels of a plurality of colors. For example, as illustrated in FIG. 2A, the image display unit 2 includes a backlight 21 being a surface light source, a two-dimensional light modulation element 22, and a barrier 23.

The two-dimensional light modulation element 22 is provided in front of the backlight 21 when viewed from the observer ob. The two-dimensional light modulation element 22 has a configuration in which modulation elements that modulate light emitted from the backlight 21 are two-dimensionally aligned. As the two-dimensional light modulation element 22, for example, a liquid crystal panel can be used.

The barrier 23 is provided in front of the two-dimensional light modulation element 22 when viewed from the observer ob. The barrier 23 transmits and blocks a portion of the light which has been emitted from the backlight 21 and modulated by the two-dimensional light modulation element 22. That is, the barrier 23 limits light observed by the observer ob.

The barrier 23 includes a plurality of opening portions. The barrier 23 transmits light through the opening portions, and blocks light with a light shielding portion other than the opening portions. For example, the barrier 23 is formed of a plate-like member having a thickness that does have an influence on the observation of the light transmitted through the opening portion even when the observer ob obliquely views the image display unit 2. Such a barrier 23 can be produced, for example, by forming a hole in a thin plate having a light shielding property in accordance with the shape of the opening portion. The barrier 23 can be produced, for example, by forming a metal thin film in accordance with the pattern of the light shielding portion on a glass plate.

In a configuration illustrated in FIG. 2A, the backlight 21 and the two-dimensional light modulation element 22 may be integrally configured. In this case, for example, a liquid crystal panel that modulates light coming from the outside of the display device, or a liquid crystal display in which a backlight and a liquid crystal panel are integrated can be used. In addition, an organic electro luminescence (EL) display or the like can also be used.

As illustrated in FIG. 2B, the image display unit 2 may have a configuration in which, when viewed from the observer ob, the barrier 23 is provided in front of the backlight 21, and the two-dimensional light modulation element 22 is disposed in front of the barrier 23. In this case, the light emitted by the backlight 21 and transmitted through the opening portion of the barrier 23 is modulated by the two-dimensional light modulation element 22 and observed by the observer ob.

In the configuration illustrated in FIG. 2B, the backlight 21 and the barrier 23 may be integrally configured. As such a configuration, for example, there are various configurations such as a configuration in which a light source such as a light emitting diode (LED) is disposed only at a position corresponding to the opening portion of the barrier 23 and a configuration in which a pattern corresponding to the opening portion of the barrier 23 and the light shielding portion is displayed on a two-dimensional display. As the two-dimensional display described above, a liquid crystal display, an organic EL display, or the like may be used.

In FIGS. 2A and 2B, the configuration in which the light emitted from the backlight 21 being the surface light source is modulated by the two-dimensional light modulation element 22 is described. Examples of a display having such a configuration include a liquid crystal display. The display applicable to the present disclosure is not limited to the display including the backlight 21 and the two-dimensional light modulation element 22 as described above. For example, a display using an organic EL display or the like can also be used. The backlight may be not only a uniform diffusion light source having Lambertian light distribution but also a directional light source. In particular, when a light source having directivity in a range in which the display device 1 can be observed is used, it is possible to improve use efficiency of light and to reduce power consumption. Furthermore, the use efficiency of light may be improved in a manner that a microlens array is provided on the front surface of the backlight 21 and collects light to individual openings of the barrier 23.

As described above, in the image display unit 2 illustrated in FIG. 2A, among beams of the light emitted from the backlight 21 and modulated by the two-dimensional light modulation element 22, the light transmitted through the opening portion of the barrier 23 is observed by the observer ob. In addition, in the image display unit 2 illustrated in FIG. 2B, among beams of the light emitted from the backlight 21, the light transmitted through the opening portion of the barrier 23 is modulated by the two-dimensional light modulation element 22 and observed by the observer ob. As described above, in the image display unit 2 according to the present embodiment, the light transmitted through the opening portion is observed by the observer ob. As described above, the barrier 23 is provided with a plurality of opening portions through which light is transmitted. Thus, the image display unit 2 according to the present embodiment causes the observer ob to observe an image configured by pixels including subpixels having a plurality of colors through a plurality of opening portions.

In the present specification, “causing the observer ob to perform observation light through the opening portion” does not refer only to causing the observer ob to observe light transmitted through the opening portion, but also includes causing the observer ob to observe light substantially equivalent to the light transmitted through the opening portion. Thus, even in a configuration that does not necessarily include the barrier 23, such as a configuration in which a light source such as an LED is disposed only at a position corresponding to the opening portion of the barrier 23 and a configuration in which a pattern corresponding to the opening portion and the light shielding portion of the barrier 23 is displayed on the two-dimensional display, the light which is substantially equivalent to the light transmitted through the opening portion is observed by the observer ob. Thus, in the present specification, “causing the observer ob to perform observation through the opening portion” includes causing the observer ob to observe an image by the image display unit 2 having these configurations.

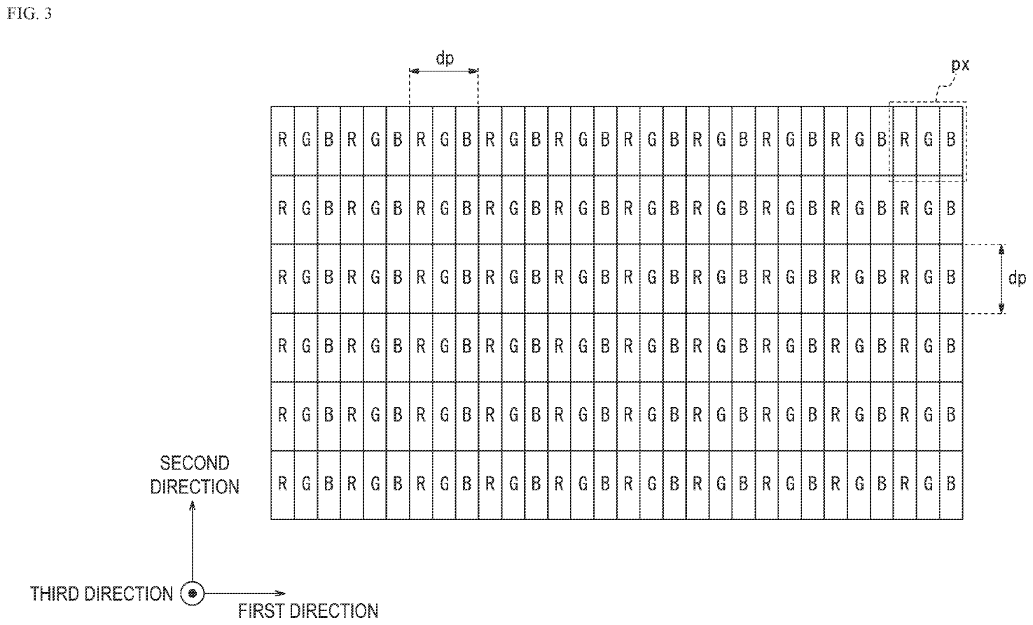

FIG. 3 is a diagram illustrating a pixel configuration of the two-dimensional light modulation element 22. As described above, in the present embodiment, an organic EL display or the like that does not include the two-dimensional light modulation element 22 can also be used as the image display unit 2. Thus, the pixel configuration of the image display unit 2 will be described below.

The image display unit 2 has a stripe structure in which subpixels having a plurality of colors are disposed such that subpixels having the same color are aligned in a predetermined direction. FIG. 3 illustrates a structure in which subpixels of three primary colors of red (R), green (G), and blue (B) are disposed in a stripe shape. A direction in which colors of adjacent subpixels change (in FIG. 3, lateral direction on paper) is referred to as a first direction below. A direction which is perpendicular to the first direction and in which subpixels of the same color are aligned (in FIG. 3, longitudinal direction on paper) is referred to as a second direction below. A direction perpendicular to the first direction and the second direction is referred to as a third direction below. Thus, the image display unit 2 has a pixel structure in which subpixels having a plurality of colors are provided, subpixels having different colors are aligned in the first direction, and subpixels having the same color are aligned in the second direction perpendicular to the first direction. The third direction is a direction of the observer ob who faces the image display unit 2 and observes the image display unit 2.

One pixel px is configured by three subpixels of a red subpixel R, a green subpixel G, and a blue subpixel B, which are aligned in the first direction. The red subpixel R, the green subpixel G, and the blue subpixel B have the same width in the first direction and have a rectangular shape in which the width in the second direction is longer than the width in the first direction. In the present embodiment, the subpixels are disposed such that the longitudinal direction is the second direction. Description will be made below on the assumption that a pixel pitch is dp in both the first direction and the second direction, that is, the widths of the pixels in the first direction and the second direction are dp (square pixels). Thus, the width of each of the red subpixel R, the green subpixel G, and the blue subpixel B in the first direction is one-third of dp. The pixel px may have a horizontally long shape that is long in the first direction or a rectangular shape that is long in the second direction. FIG. 3 illustrates an example in which a direction in which the subpixels having the same color are aligned is longitudinal direction on paper (longitudinal stripe). The present disclosure is not limited thereto. For example, the subpixels having the same color may be disposed in a checkered pattern.

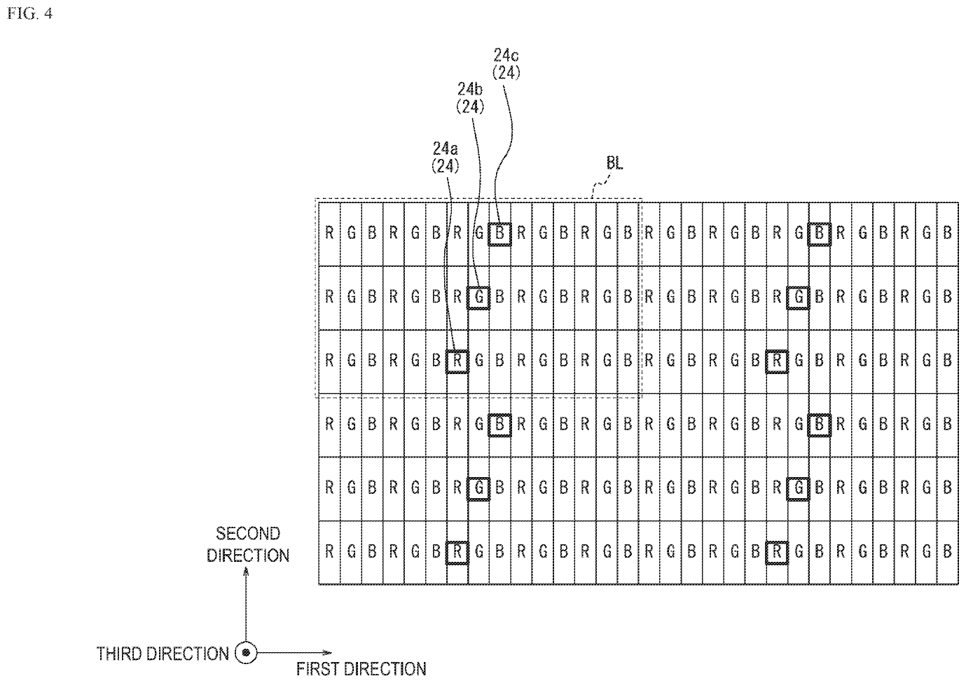

FIG. 4 is a diagram illustrating an example of a positional relation between the pixel configuration of the image display unit 2 and the opening portion 24 provided in the barrier 23.

A plurality of opening portions 24 are formed for each pixel block BL including a plurality of pixels px. More specifically, for each pixel block BL, at least opening portions 24 of which the number is equal to the number of colors of the subpixels are disposed. In the present embodiment, since one pixel is configured by subpixels of three colors of red, green, and blue, at least three opening portions 24 (opening portions 24a, 24b, and 24c) are disposed for each pixel block BL. FIG. 4 illustrates an example in which the opening portions 24a, 24b, and 24c are disposed in a pixel block BL (pixel block BL of 5×3) including the pixels px (that is, 15 pixels px) of 5 pixels in the first direction and 3 pixels in the second direction.

The opening portions 24a, 24b, and 24c are disposed near the center of the pixel block BL in the first direction. The opening portion 24a is disposed on the red subpixel R.

The opening portion 24b is disposed on the green subpixel G constituting a pixel px in a row different from a row of the pixel px (referred to as a “pixel px corresponding to the opening portion 24a” below) including the subpixel on which the opening portion 24a is disposed. More specifically, the opening portion 24b is disposed on the green subpixel G constituting the pixel px on the back side by one pixel in the second direction with respect to the pixel px corresponding to the opening portion 24a.

The opening portion 24c is disposed on the blue subpixel B constituting a pixel px in a row different from a row of the pixel px corresponding to the opening portion 24b. More specifically, the opening portion 24c is disposed on the blue subpixel B constituting the pixel px on the back side by one pixel in the second direction with respect to the pixel px corresponding to the opening portion 24b. That is, the plurality of opening portions 24 (opening portions 24a, 24b, and 24c) disposed in the pixel block BL are disposed to be shifted in the first direction.

The opening portion 24 has a rectangular shape. The width of the opening portion 24 in the first direction is substantially equal to the width of the subpixel in the first direction. The width (height) of the opening portion 24 in the second direction is, for example, one-fifth of the pixel pitch, but is not limited thereto, and may be set to any value. The width of the opening portion 24 in the second direction is a length of a line segment obtained by the opening portion 24 cutting a certain straight line that is parallel to the second direction and passes through the opening portion 24. When the width of the opening portion 24 in the second direction is increased, the observed image becomes brighter, but the “viewing region” described later becomes narrower. When the width of the opening portion 24 in the second direction is reduced, the observed image becomes dark, but the viewing region becomes large. Thus, the width of the opening portion 24 in the second direction is set in accordance with the application of the display device 1.

The image display unit 2 causes the observer ob to observe an image through the plurality of opening portions 24 disposed for each pixel block BL. Here, the subpixel observed through the opening portion 24 changes with the change in the observation position. Thus, by controlling the display of the subpixel observed when viewed from a predetermined observation position through the opening portion 24 in accordance with an image from the observation position, it is possible to cause the observer ob to observe an image in which motion parallax is reproduced.

In FIG. 4, the opening portion 24 is disposed corresponding to each of three pixels px (pixels px of which the number is equal to the number of colors of the subpixels) that are continuous in the second direction and are included in the pixel block BL. The number of pixels px that are continuous in the second direction and are included in the pixel block BL may be more than the number of colors of the subpixels. That is, the pixel block BL may include at least the pixels of which the number is equal to the number of colors of the subpixels, in the second direction. The opening portions 24 may be disposed corresponding to each of the pixels px of which the number is equal to the number of colors of the subpixel, the pixels px being continuous in the second direction. With such a configuration, even though the observation position moves in the second direction, it is possible to make it difficult for the observed image to be deformed.

The plurality of opening portions 24 aligned in the first direction may be disposed at regular intervals. For the “viewpoint” described later, the observation position can be set every time the subpixel observed through the opening portion 24 is shifted by one subpixel. When there is a region in which the interval between the opening portions 24 in the first direction is narrow, the number of viewpoints decreases. By disposing the plurality of opening portions 24 aligned in the first direction at regular intervals, it is possible to provide an image in which motion parallax is reproduced, by efficiently using the pixel px.

In the display device 1 according to the present embodiment, when the observation position of the observer ob changes, the position of the opening portion 24 apparently moves with respect to the two-dimensional light modulation element 22, and thereby linear blending is implemented. The principle of linear blending in the display device 1 according to the present embodiment will be described.

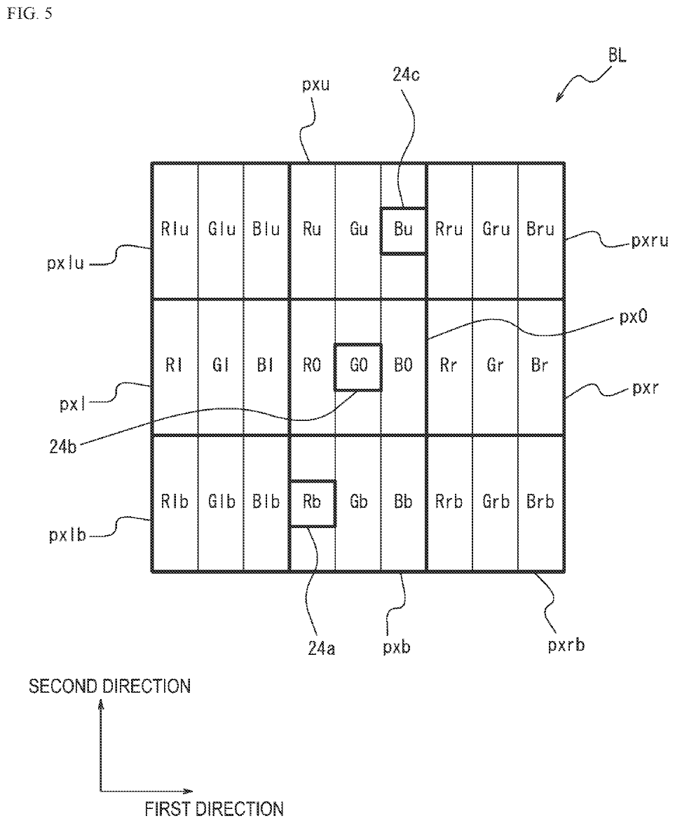

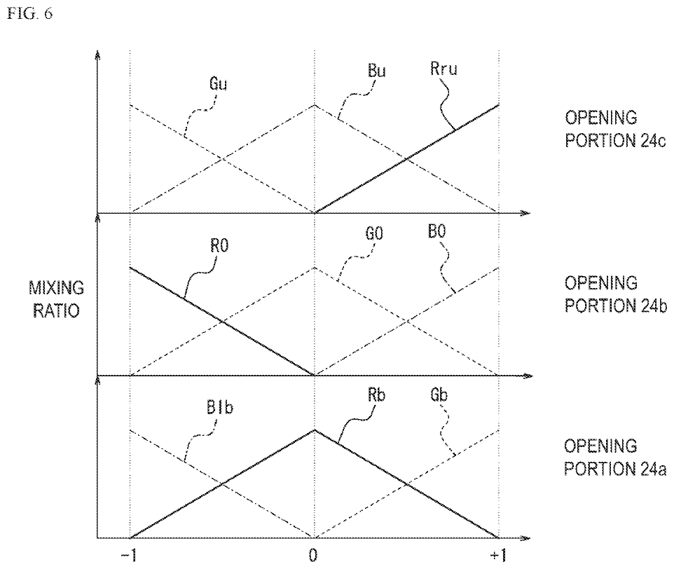

As illustrated in FIG. 5, it is assumed below that three opening portions 24a, 24b, and 24c are disposed in a pixel block BL including 3×3 pixels px (pixels pxlu, pxl, pxlb, pxu, px0, pxb, pxru, pxr, pxrb). In addition, it is assumed below that the opening portion 24a is disposed on a red subpixel Rb constituting the pixel pxb, the opening portion 24b is disposed on a green subpixel G0 constituting the pixel px0, and the opening portion 24c is disposed on a blue subpixel Bu constituting the pixel pxu. FIG. 6 illustrates a change in a mixing ratio (area ratio) of the subpixels observed through the opening portions 24a, 24b, and 24c when the opening portions 24a, 24b, and 24c are apparently moved by one subpixel (+1) in a right direction or moved by one subpixel (−1) in a left direction from the state (0) illustrated in FIG. 5.

As illustrated in FIG. 6, as the opening portion 24a apparently moves in the left direction, the area of the red subpixel Rb observed through the opening portion 24a is linearly reduced, and the area of the blue subpixel Blb on the left of the red subpixel Rb, which is observed through opening portion 24a is linearly increased. As the opening portion 24a apparently moves in the right direction, the area of the red subpixel Rb observed through the opening portion 24a is linearly reduced, and the area of the green subpixel Gb on the right of the red subpixel Rb, which is observed through opening portion 24a is linearly increased.

As illustrated in FIG. 6, as the opening portion 24b apparently moves in the left direction, the area of the green subpixel G0 observed through the opening portion 24b is linearly reduced, and the area of the red subpixel R0 on the left of the green subpixel G0, which is observed through opening portion 24b is linearly increased. As the opening portion 24b apparently moves in the right direction, the area of the green subpixel G0 observed through the opening portion 24b is linearly reduced, and the area of the blue subpixel B0 on the right of the green subpixel G0, which is observed through opening portion 24b is linearly increased.

As illustrated in FIG. 6, as the opening portion 24c apparently moves in the left direction, the area of the blue subpixel Bu observed through the opening portion 24c is linearly reduced, and the area of the green subpixel Gu on the left of the blue subpixel Bu, which is observed through opening portion 24c is linearly increased. As the opening portion 24c apparently moves in the right direction, the area of the blue subpixel Bu observed through the opening portion 24c is linearly reduced, and the area of the red subpixel Rru on the right of the blue subpixel Bu, which is observed through opening portion 24c is linearly increased.

As described above, in the display device 1 according to the present embodiment, the areas of the subpixels having the plurality of colors, which are observed from a certain observation position through the plurality of opening portions 24 are equal to each other. Thus, for each of red, green, and blue colors, the mixing ratio changes linearly in accordance with the change of the observation position in the first direction, and thus linear blending is implemented. In FIG. 6, an example in which the opening portions 24a, 24b, and 24c apparently move by one subpixel in the left and right directions is described. When the opening portions 24a, 24b, and 24c apparently move by two or more subpixels in the left and right directions, linear blending is similarly implemented.

In the display device 1 according to the present embodiment, an observation range is expanded by increasing the number of viewpoints and increasing the number of viewing regions in comparison to the display device disclosed in PTL 3. Each of the “observation range”, the “viewing region”, and the “viewpoint” will be described.

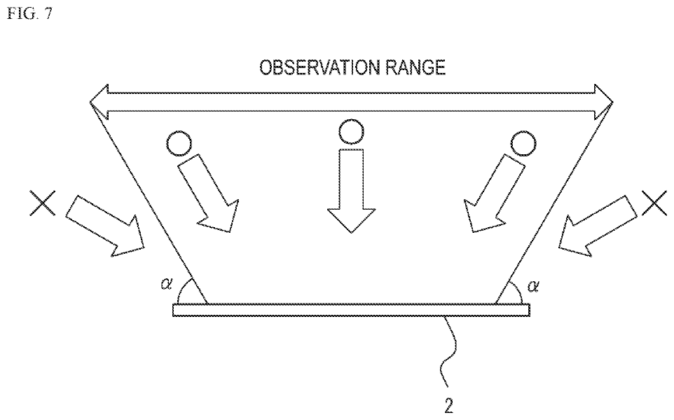

First, the “observation range” will be described with reference to FIG. 7. The “observation range” is a range in which images from different observation positions can be smoothly observed without distortion by linear blending.

For example, as illustrated in FIG. 7, it is assumed that a distorted image (for example, an image with trapezoidal distortion) is observed in a range in which an angle α at which the observer ob observes the image display unit 2 is smaller than a predetermined value, and an image corresponding to the observation position can be smoothly observed without distortion in a range in which the angle α is equal to or larger than the predetermined value. In this case, the range in which the angle α is equal to or larger than the predetermined value is the “observation range”. “An image corresponding to an observation position can be observed” means the followings. For example, when viewed from the right side of the image display unit 2, an image on the left side of a target is observed. When viewed from the front of the image display unit 2, an image on the front side of the target is observed. When viewed from the left side of the image display unit 2, an image on the right side of the target is observed. The observation range changes depending on the positional relation between the opening portion 24 of the barrier 23 and the two-dimensional light modulation element 22, and the like.

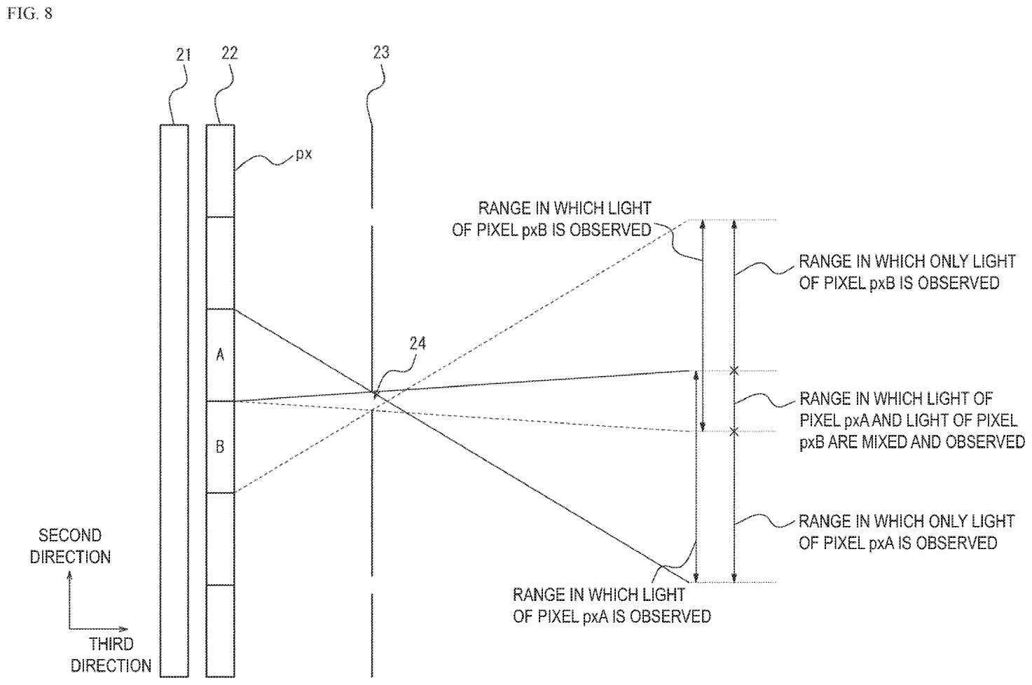

Next, the “viewing region” will be described with reference to FIG. 8.

FIG. 8 is a cross-sectional view of the image display unit 2 along the second direction at a certain position at which the opening portion 24 is disposed.

The “viewing region” is a range in which only the color of one subpixel is observed in the second direction. As illustrated in FIG. 8, light emitted from the subpixel constituting a pixel pxA is transmitted through the opening portion 24 and spreads radially. Light emitted from the subpixel constituting a pixel pxB adjacent to the pixel pxA in the second direction is transmitted through the opening portion 24 and spreads radially. Thus, a range in which the light of the pixel pxA is observed and a range in which the light of the pixel pxB is observed partially overlap each other. As described above, the viewing region is a range in which only the color of one subpixel is observed in the second direction.

Thus, in FIG. 8, a range in which only the light of the pixel pxA (the subpixel constituting the pixel pxA) is observed and a range in which only the light of the pixel pxB (the subpixel constituting the pixel pxB) is observed are the “viewing regions”. That is, in FIG. 8, two “viewing regions” can be set. By controlling the display of the image display unit 2 so that different images are observed in different viewing regions (controlling the display of the subpixel of the pixel pxA and the subpixel of the pixel pxB), it is possible to cause an image corresponding to the observation position to be observed with the observation position moving in the second direction.

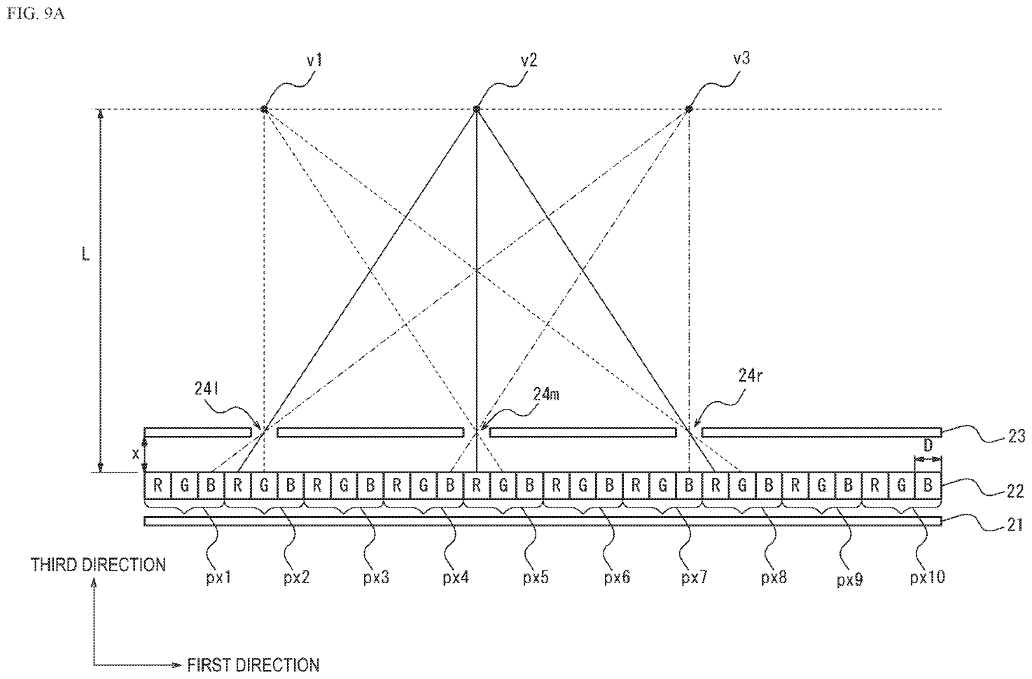

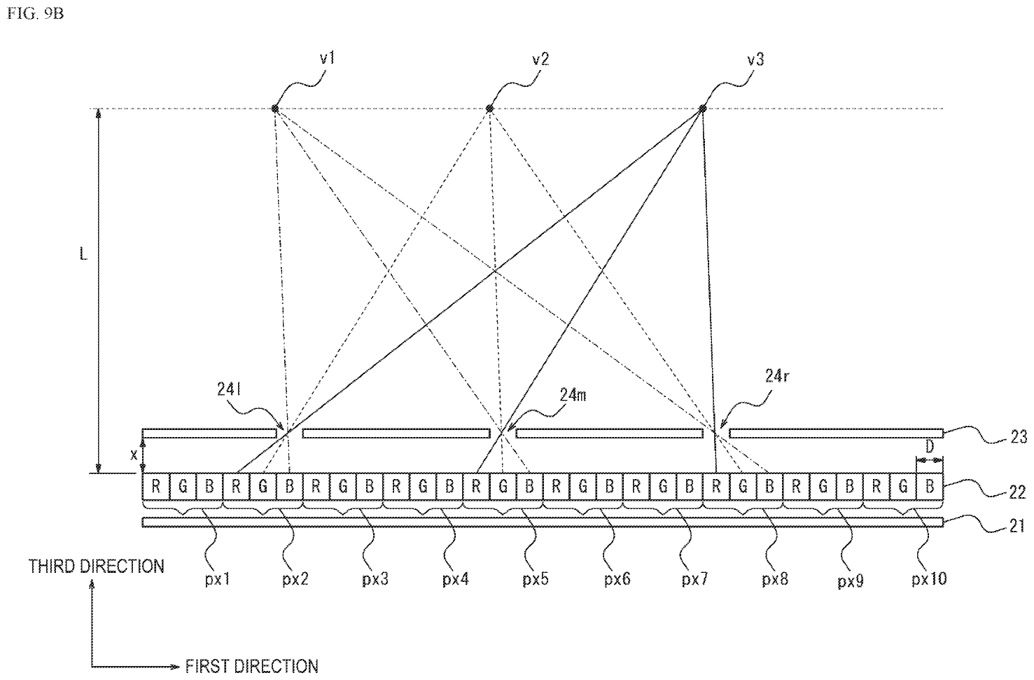

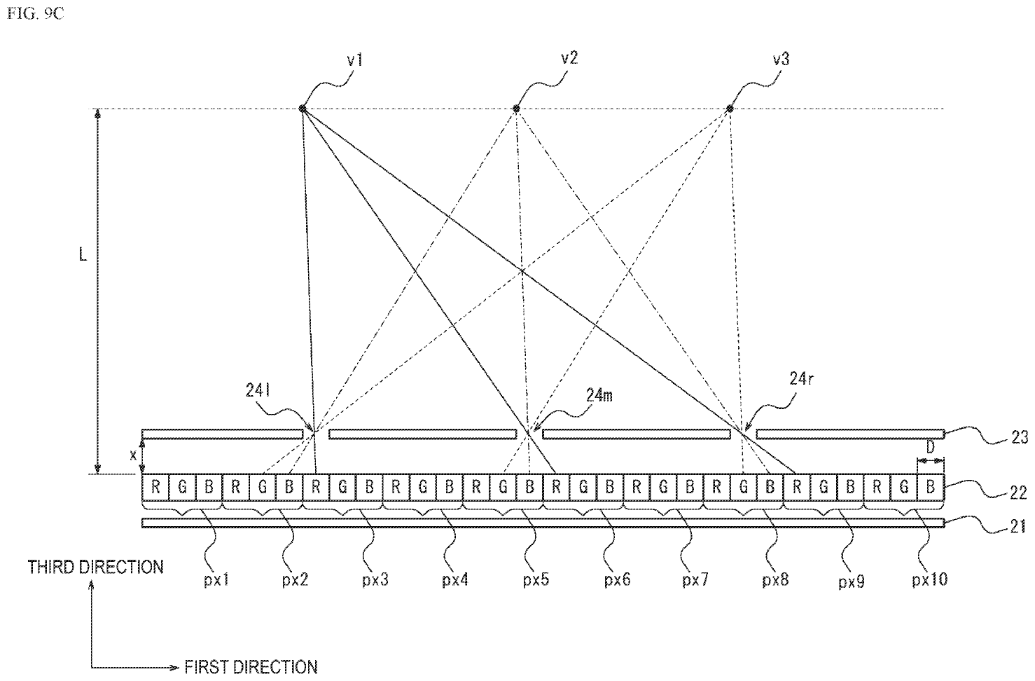

Next, the “viewpoint” will be described with reference to FIGS. 9A to 9C.

FIG. 9A is a cross-sectional view of the image display unit 2 along the first direction at a certain position at which the opening portion 24 is disposed. In FIG. 9A, the entirety of the barrier 23 is reduced with respect to the disposition in which the subpixel is immediately below the opening portion 23. Thus, the widths of opening portions 24l, 24m, and 24r and an interval between adjacent opening portions are narrowed. This is a result of contrivance for forming the “viewpoint”, and details will be described later. FIG. 9A illustrates 10 pixels px (pixels px1 to px10) and 3 opening portions 24 (left opening portion 24l, central opening portion 24m, right opening portion 24r) aligned in the first direction. In FIG. 9A, the shift in the drawing occurs due to the contrivance of the viewpoint formation. Since the width of the opening portion 24l and a distance x between the two-dimensional light modulation element 22 and the barrier 23 are very small in comparison to a distance L from the observation position to the display device 1, the actual reduction amount of the barrier 23 is very small. Thus, in actual, the opening portion 24l is substantially disposed on a red subpixel R of the pixel px2. In addition, the width of the opening portion 24 is slightly narrower than the width of the subpixel although not as wide as in the drawing. In FIG. 9A, the shift is similarly emphasized in the drawing for the disposition of the other opening portions 24m and 24r. The description will be made below based on the actual disposition. The same is applied to FIGS. 9B and 9C described later. The opening portion 24m is substantially disposed on a red subpixel R of the pixel px5. The opening portion 24r is substantially disposed on a red subpixel R of the pixel px8.

The “viewpoint” is a point at which, when the image display unit 2 is viewed from a third direction perpendicular to the first direction and the second direction, the center of each opening portion 24 intersects a straight line passing through the center of a certain subpixel.

In FIG. 9A, an intersection between a straight line that passes through the center of the green subpixel G of the pixel px2 and the center of the opening portion 24l, a straight line that passes through the center of the green subpixel G of the pixel px5 and the center of the opening portion 24m, and a straight line that passes through the center of the green subpixel G of the pixel px8 and the center of the opening portion 24r is set as a viewpoint v1. The above straight lines are indicated by dotted lines. An intersection between a straight line that passes through the center of the red subpixel R of the pixel px2 and the center of the opening portion 24l, a straight line that passes through the center of the red subpixel R of the pixel px5 and the center of the opening portion 24m, and a straight line that passes through the center of the red subpixel R of the pixel px8 and the center of the opening portion 24r is set as a viewpoint v2. The above straight lines are indicated by solid lines. An intersection between a straight line that passes through the center of the blue subpixel B of the pixel px1 and the center of the opening portion 24l, a straight line that passes through the center of the blue subpixel B of the pixel px4 and the center of the opening portion 24m, and a straight line that passes through the center of the blue subpixel B of the pixel px7 and the center of the opening portion 24r is set as a viewpoint v3. The above straight lines are indicated by one-dot chain lines. Thus, light of the green subpixel G is observed from the viewpoint v1. From the viewpoint v2, light of the red subpixel R is observed. From the viewpoint v3, light of the blue subpixel B is observed.

FIG. 9B is a cross-sectional view of the image display unit 2 along the first direction at the position of the opening portion 24 disposed corresponding to the pixel px on the back side by one pixel in the second direction with respect to the opening portion 24 illustrated in FIG. 9A. Thus, pixels px1 to px10 illustrated in FIG. 9B are pixels px disposed on the back side by one pixels in the second direction with respect to the pixels px1 to px10 illustrated in FIG. 9A. As described above, the opening portion 24 is disposed to be shifted to the right side in the first direction by one subpixel with respect to the opening portion 24 on the front side by one in the second direction. Thus, in FIG. 9B, the left opening portion 24l is substantially disposed on the green subpixel G of the pixel px2. The central opening portion 24m is substantially disposed on the green subpixel G of the pixel px5. The right opening portion 24r is substantially disposed on the green subpixel G of the pixel px8.

A straight line that passes through the center of the blue subpixel B of the pixel px2 and the center of the opening portion 24l, a straight line that passes through the center of the blue subpixel B of the pixel px5 and the center of the opening portion 24m, and a straight line that passes through the center of the blue subpixel B of the pixel px8 and the center of the opening portion 24r intersect each other at the viewpoint v1 as in FIG. 9A. The above straight lines are indicated by one-dot chain lines. A straight line that passes through the center of the green subpixel G of the pixel px2 and the center of the opening portion 24l, a straight line that passes through the center of the green subpixel G of the pixel px5 and the center of the opening portion 24m, and a straight line that passes through the center of the green subpixel G of the pixel px8 and the center of the opening portion 24r intersect each other at the viewpoint v2 as in FIG. 9A. The above straight lines are indicated by dotted lines. A straight line that passes through the center of the red subpixel R of the pixel px2 and the center of the opening portion 24l, a straight line that passes through the center of the red subpixel R of the pixel px5 and the center of the opening portion 24m, and a straight line that passes through the center of the red subpixel R of the pixel px8 and the center of the opening portion 24r intersect each other at the viewpoint v3 as in FIG. 9A. The above straight lines are indicated by solid lines. Thus, light of the blue subpixel B is observed from the viewpoint v1. From the viewpoint v2, light of the green subpixel G is observed. From the viewpoint v3, light of the red subpixel R is observed.

FIG. 9C is a cross-sectional view of the image display unit 2 along the first direction at the position of the opening portion 24 disposed corresponding to the pixel px on the back side by one pixel in the second direction with respect to the opening portion 24 illustrated in FIG. 9B. Thus, pixels px1 to px10 illustrated in FIG. 9C are pixels px disposed on the back side by one pixels in the second direction with respect to the pixels px1 to px10 illustrated in FIG. 9B. As described above, the opening portion 24 is disposed to be shifted to the right side in the first direction by one subpixel with respect to the opening portion 24 on the front side by one in the second direction. Thus, in FIG. 9C, the left opening portion 24l is substantially disposed on the blue subpixel B of the pixel px2. The central opening portion 24m is substantially disposed on the blue subpixel B of the pixel px5. The right opening portion 24r is substantially disposed on the blue subpixel B of the pixel px8.

A straight line that passes through the center of the red subpixel R of the pixel px3 and the center of the opening portion 24l, a straight line that passes through the center of the red subpixel R of the pixel px6 and the center of the opening portion 24m, and a straight line that passes through the center of the red subpixel R of the pixel px9 and the center of the opening portion 24r intersect each other at the viewpoint v1 as in FIG. 9A. The above straight lines are indicated by solid lines. A straight line that passes through the center of the blue subpixel B of the pixel px2 and the center of the opening portion 24l, a straight line that passes through the center of the blue subpixel B of the pixel px5 and the center of the opening portion 24m, and a straight line that passes through the center of the blue subpixel B of the pixel px8 and the center of the opening portion 24r intersect each other at the viewpoint v2 as in FIG. 9A. The above straight lines are indicated by one-dot chain lines. A straight line that passes through the center of the green subpixel G of the pixel px2 and the center of the opening portion 24l, a straight line that passes through the center of the green subpixel G of the pixel px5 and the center of the opening portion 24m, and a straight line that passes through the center of the green subpixel G of the pixel px8 and the center of the opening portion 24r intersect each other at the viewpoint v3 as in FIG. 9A. The above straight lines are indicated by dotted lines. Thus, light of the red subpixel R is observed from the viewpoint v1. From the viewpoint v2, light of the blue subpixel B is observed. From the viewpoint v3, light of the green subpixel G is observed.

As described above, the light from the red subpixel R, the green subpixel G, and the blue subpixel B is observed at the viewpoints v1, v2, and v3, respectively. Thus, by controlling the display of the subpixel observed from each viewpoint in accordance with an image from the viewpoint position, it is possible to cause an image corresponding to the observation position with the observation position moving in the first direction.

In the display device 1 according to the present embodiment, the “viewpoint” in the observation range can be set every time the observation position moves by a shift of one subpixel (one-third of dp) from the subpixel observed through the opening portion 24. In the technique disclosed in PTL 3, the “viewpoint” in the observation range is set every time the pixel observed through the opening portion is shifted by one pixel (dp). Thus, according to the display device 1 of the present embodiment, it is possible to increase the number of viewpoints from which an image in which motion parallax is reproduced can be observed, and to make an expression with high sense of realism.

The position and the width of the opening portion 24 are adjusted so that a line passing through the center of each opening portion 24 and the center of a certain subpixel intersects. Specifically, as illustrated in FIGS. 9A to 9C, when the distance L is set to a distance from the observation position to the display device 1, the position and the width of the opening portion 24 are adjusted so that a point spaced from the display device 1 by the distance L, the center of the subpixel, and the center of the opening portion 24 are aligned on one straight line. Here, since the distance L (for example, several m) is very greater than the width (for example, several tens of μm) of the opening portion 24, the adjustment amounts of the position and the width of the opening portion 24 are small values close to errors.

As illustrated in FIGS. 9A to 9C, when the width of the subpixel in the first direction is set as D, the distance from the observation position to the display device 1 is set as L, and the distance between the two-dimensional light modulation element 22 and the barrier 23 is set as x, the width D′ of the opening portion 24 in the first direction is calculated by, for example, Expression (1) as follows.

$$\begin{matrix}[ Math . 1 ] & \\ {D}^{′} = \frac{L - x}{L} D & Expression ( 1 )\end{matrix}$$

In general, the distance x between the two-dimensional light modulation element 22 and the barrier 23 is about several mm (for example, about 2 mm). The distance L from the observation position to the display device 1 is about several meters (for example, about 1 m). Thus, the width D′ of the opening portion 24 in the first direction is smaller than the width D of the subpixel in the first direction. The difference between the width D′ of the opening portion 24 in the first direction and the width D of the subpixel in the first direction is very small.

In processing opening portion 24, zigzag may occur at an edge of the opening portion 24, or rounding may occur at a corner of the opening portion 24. Thus, considering such a processing error, the width of the opening portion 24 in the first direction may be set to be smaller than the width D of the subpixel in the first direction.

In addition, considering spreading due to diffraction of light passing through the opening portion 24, the width of the opening portion 24 in the first direction may be set to be smaller than the width D of the subpixel in the first direction.

As described with reference to FIG. 4, the width of the opening portion 24 in the first direction is substantially equal to the width of the subpixel in the first direction. Here, “being substantially equal” includes a case where the width of the opening portion 24 in the first direction is slightly smaller than the width of the subpixel in the first direction, which is obtained by Expression (1) or obtained in consideration of a processing error of the opening portion 24 and diffraction of light passing through the opening portion 24.

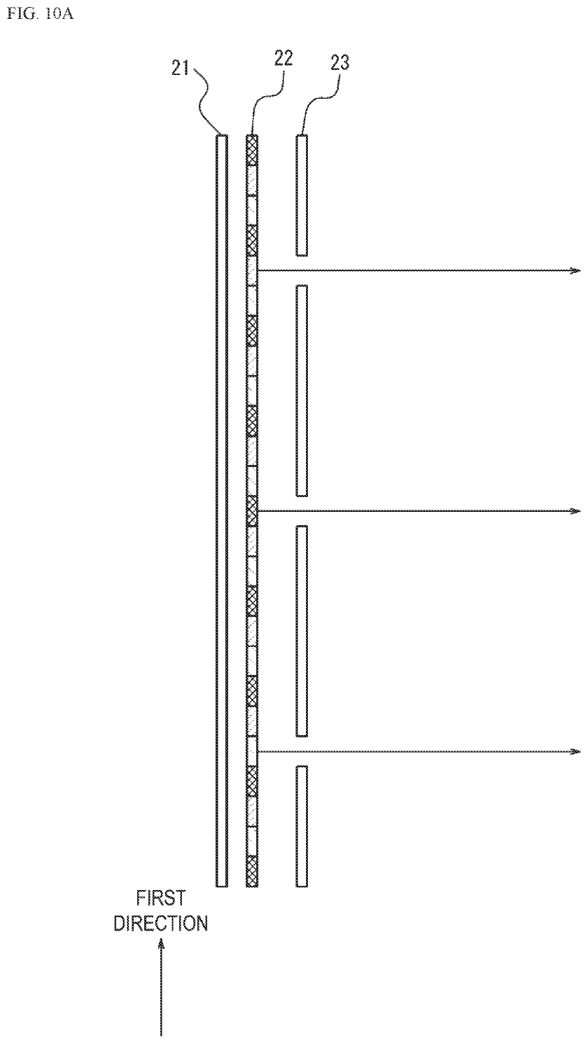

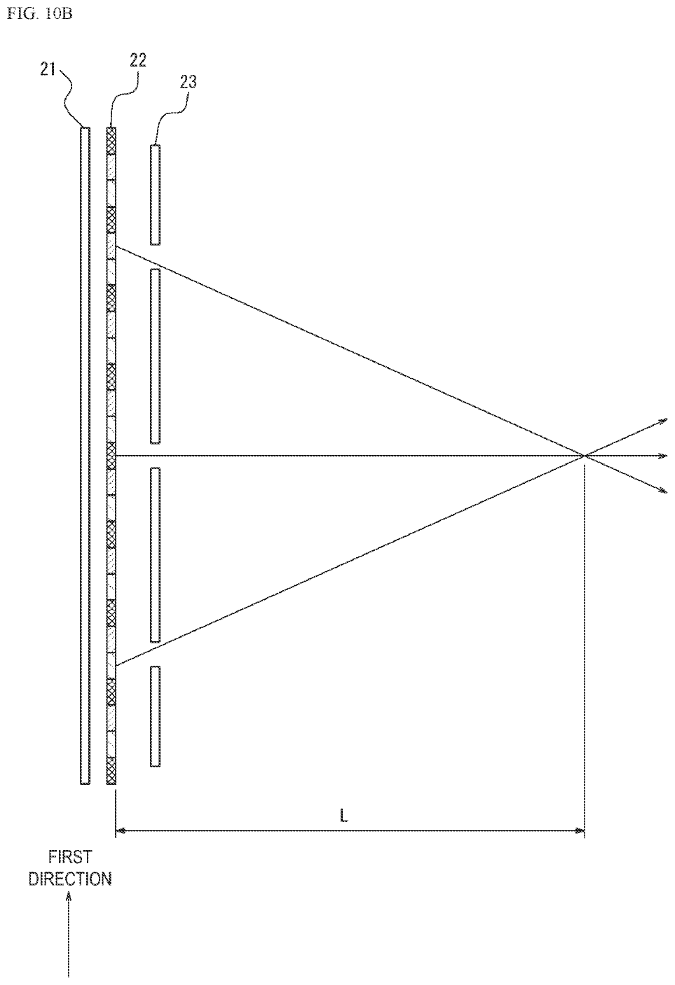

Assuming that the width of the opening portion 24 in the first direction is equal to the width of the subpixel in the first direction, a direction in which the mixing ratio of the light from the subpixels observed through the plurality of opening portions 24 is constant is parallel between the different pixels px, as illustrated in FIG. 10A. In this case, when viewed from infinity, the mixing ratio of the light of the subpixels having the plurality of colors is constant. Thus, it is suitable for observation from a relatively distant place.

As illustrated in FIG. 10B, when the entirety of the barrier 23 is reduced, a convergence point of an arrow indicating the direction in which the mixing ratio becomes constant becomes close to the image display unit 2. Thus, it becomes suitable for observation from a short distance. When the image display unit 2 has the configuration illustrated in FIG. 2B, it is possible to obtain a similar effect by enlarging the entirety of the barrier 23.

When the entirety of the barrier 23 is reduced or enlarged, the opening portion 24 is also enlarged or reduced. Here, when the width of the pixel px in the first direction is set as D, the width of the opening portion 24 in the first direction is set as D′, the distance between the pixel px and the barrier 23 is set as x, and the distance from the image display unit 2 to the observation position is set as L, the relation between the width D of the pixel px in the first direction and the width D′ of the opening portion 24 in the first direction is represented by Expression (1) described above. The state in which the width of the opening portion 24 in the first direction is “substantially equal” to the width of the subpixel in the first direction includes a case in which the barrier 23 is reduced or enlarged in accordance with the distance between the pixel px and the barrier and the distance L from the image display unit 2 to the observation position.

As is apparent from FIGS. 10A and 10B, when the positional relation between the pixel px and the opening portion 24 are shifted from each other, the direction of a light beam with respect to the pixel px is shifted from the designed condition. Thus, in order to adjust the positional relation between the two-dimensional light modulation element 22 and the barrier 23, an adjustment mechanism capable of relatively translating movement in two in-plane directions and in-plane rotation may be provided. It is desirable that the shift of the subpixel from an ideal state at least in the entire screen, that is, a state in which the positional relation between the subpixel and the opening portion 24 strictly coincides is smaller than one subpixel, and more preferably smaller than one-tenth of the subpixel. The adjustment may be performed by the adjustment mechanism so that the shift of the subpixel falls within this range. The adjustment mechanism as described above increases the price of the device. Thus, an image at the observation position shifted to compensate for the relative positional shift may be displayed.

Next, a display method in the display device 1 according to the present embodiment will be described. An example in which three opening portions 24 (opening portions 24a, 24b, and 24c) are disposed in a pixel block BL of 5×3 illustrated in FIG. 4 will be described below.

As described above, in the display device 1 according to the present embodiment, the viewpoint is set every time the subpixel observed through the opening portion 24 is shifted by one subpixel. Thus, in the pixel block BL of 5×3, 15 viewpoints can be set in the first direction.

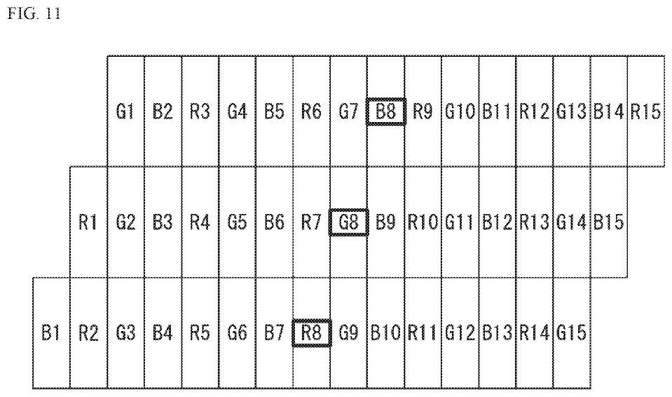

FIG. 11 is a diagram illustrating an example of the pixel configuration of the image display unit 2. As described above, the image display unit 2 has a pixel configuration in which subpixels having different colors are aligned in the first direction and subpixels having the same color are aligned in the second direction. In FIG. 11, in order to display one pixel constituting an image to be displayed, the same numbers (“1” to “15”) are assigned to the combination of a red subpixel R, a green subpixel G, and a blue subpixel B, the display of which is controlled by the control unit 3. As illustrated in FIG. 11, the control unit 3 controls display of the red subpixel R, the green subpixel G, and the blue subpixel B shifted by one subpixel in each of the first direction and the second direction, in accordance with one pixel constituting the image to be displayed.

The control unit 3 displays an image (may be referred to as a “directional image” below) obtained by viewing a target from a predetermined observation position (set different viewpoint) on the image display unit 2. Specifically, the control unit 3 distributes an image from one viewpoint to a combination of a red subpixel R, a green subpixel G, and a blue subpixel B having a number corresponding to the viewpoint and displays the image.

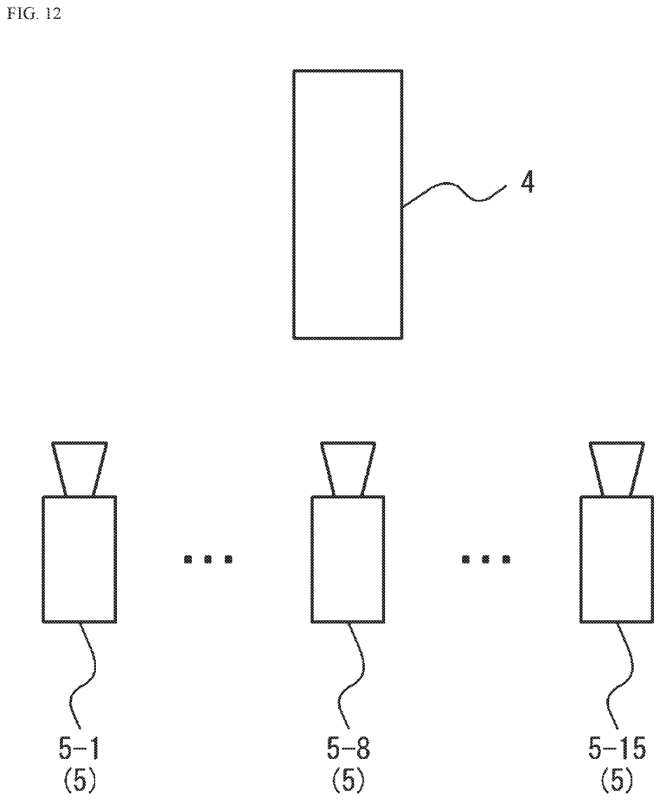

For example, as illustrated in FIG. 12, the image displayed in the display device 1 is an image captured by disposing 15 cameras 5 (5-1, . . . , and 5-15) in a line in a direction along the first direction in which the subpixels having different colors are aligned, toward a capturing target 4 so that optical axes of the cameras 5 are parallel to each other. The position of each camera 5 corresponds to the position of the viewpoint of the image display unit 2. A plurality of cameras 5 may be disposed inward so that the optical axis of each camera 5 is directed toward a specific convergence point, and capturing may be performed. Then, an image obtained by correcting the trapezoid of the captured image may be used as a display image.

The control unit 3 controls the display of the subpixel observed when viewed from a predetermined observation position (set viewpoint) through the opening portion 24, in accordance with an image from the viewpoint. For example, the control unit 3 controls the display of the red subpixel R, the green subpixel G, and the blue subpixel B observed from the viewpoint of the camera 5-1 through the opening portion 24, in accordance with the captured image of the camera 5-1 disposed on the leftmost side among the 15 cameras illustrated in FIG. 12.

Specifically, the control unit 3 controls the display of the subpixels (red subpixel R15, green subpixel G15, and blue subpixel B15) on the rightmost side, which are illustrated in FIG. 11, in accordance with the captured image of the camera 5-1. In addition, the control unit 3 controls the display of the middle subpixel (red subpixel R8, green subpixel G8, and blue subpixel B8) illustrated in FIG. 11, in accordance with the captured image of the camera 5-8 disposed in the middle among the 15 cameras. In addition, the control unit 3 controls the display of the subpixels (red subpixel R1, green subpixel G1, and blue subpixel B1) on the leftmost side, which are illustrated in FIG. 11, in accordance with the captured image of the camera 5-15 disposed on the leftmost side among the 15 cameras.

By controlling the display of the subpixel observed when viewed from the predetermined observation position (set viewpoint) through the opening portion 24, in accordance with the image from the viewpoint, it is possible to cause an image corresponding to each observation position to be observed with respect to the movement of the observation position in the first direction.

Preferably, the control unit 3 displays an image in which the parallax of the image displayed in the combination of adjacent subpixels (combination of subpixels having consecutive numbers) is equal to or smaller than 10 minutes, more preferably equal to or smaller than 5 minutes. The parallax of the image is an amount obtained by representing the shift δ between images of adjacent viewpoints on a screen by an angle when viewed from the assumed distance L. The parallax of the image is represented as follows.

$$2 tan \frac{δ}{2 L} \qquad [ Math . 2 ]$$

In a general captured image, the parallax greatly varies depending on the distance. Thus, in capturing a display image, capturing may be performed in front of a plain background so that a region having large parallax is not generated. Images may be translated and displayed to minimize the parallax of a subject. In this manner, it is possible to improve the image quality of an image to be observed. That is, it is possible to improve the image quality of an image to be observed, by adjusting the convergence. A similar effect can be obtained by using a lens having a shallow depth of field and blurring a distant view other than the subject.

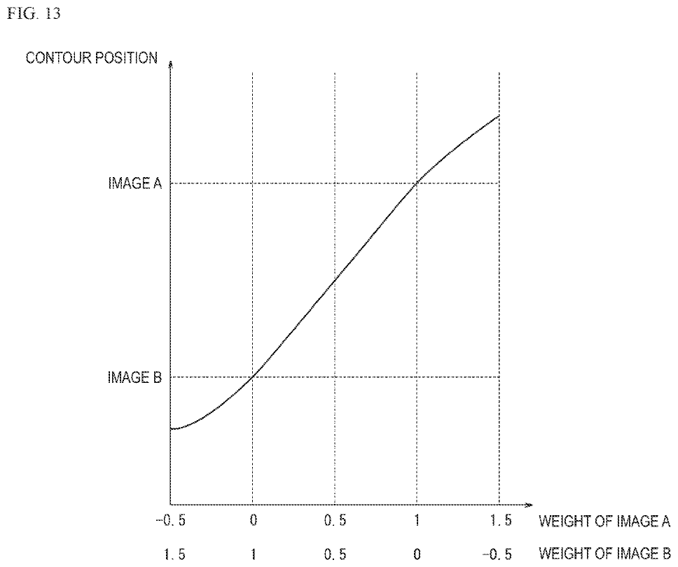

FIG. 13 is a diagram illustrating a relation between a weighted average of two images (image A and image B) and a contour position. When a directional image is displayed so that the width of a shift of an image between the adjacent viewpoints has a small value of about 3 [arc min], the contour position changes linearly and continuously when a weighting ratio has a value of 0 to 1 as illustrated in FIG. 13. Thus, an image of an appropriate contour position at the viewpoint position is generated. That is, an image of an intermediate viewpoint is faithfully perceived by connecting two images having the small image shift at a ratio that linearly changes. In the case of an image having a small high-frequency component of a spatial frequency, the image of the intermediate viewpoint is perceived even though the width of the shift is about 10 [arc min].

In the above-described embodiment, an example in which the three opening portions 24 (opening portions 24a, 24b, and 24c) are disposed for each pixel block BL of 5×3, and each opening portion 24 is disposed on a subpixel is described, but the present disclosure is not limited thereto.

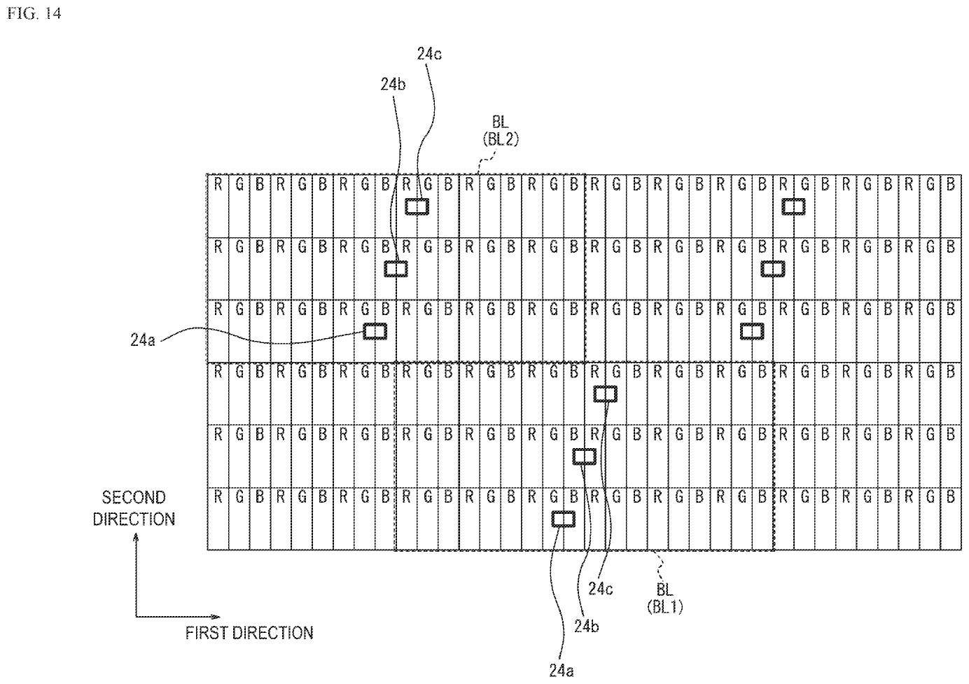

FIG. 14 is a diagram illustrating another example of the positional relation between the pixel configuration of the image display unit 2 and the opening portion 24 provided in the barrier 23.

FIG. 14 illustrates an example in which three opening portions 24 (opening portions 24a, 24b, and 24c) are disposed in a pixel block BL of 6×3. In FIG. 14, the opening portion 24a is disposed across the green subpixel G and the blue subpixel B in the vicinity of the center of the pixel block BL in the first direction. The opening portion 24b is disposed across the blue subpixel B and the red subpixel R in the vicinity of the center of the pixel block BL in the first direction. The opening portion 24c is disposed across the red subpixel R and the green subpixel Gin the vicinity of the center of the pixel block BL in the first direction. Also in FIG. 14, the width of the opening portion 24 in the first direction substantially equal to the width of the subpixel in the first direction. The plurality of opening portions 24 are disposed to be shifted in the first direction. With such a configuration, in the configuration illustrated in FIG. 14, 18 viewpoints can be set in the first direction.

In FIG. 14, pixel blocks BL adjacent in the second direction are disposed to be shifted in the first direction. Specifically, a pixel block BL1 including three rows of pixels on the front side in the second direction and a pixel block BL2 on the back side of the pixel block BL1 by one in the second direction are shifted from each other by three pixels in the first direction. Thus, the opening portion 24 (opening portions 24a, 24b, and 24c) disposed in the pixel block BL1 and the opening portion 24 (opening portions 24a, 24b, and 24c) disposed in the pixel block BL2 are also shifted from each other by 3 pixels in the first direction. With such a configuration, it is possible to make the effective resolutions in the first direction and the second direction the same.

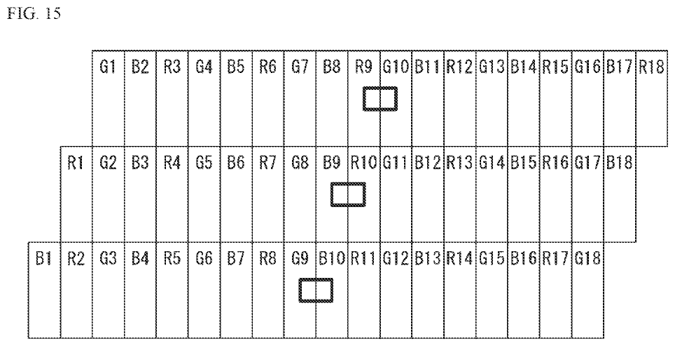

FIG. 15 is a diagram for explaining the display method in the display device 1 including the image display unit 2 illustrated in FIG. 14.

As described above, in FIG. 14, 18 viewpoints can be set in the first direction. Thus, a directional image obtained by viewing a target from 18 predetermined observation positions (viewpoints) in maximum aligned in a direction along the first direction in which subpixels having different colors are aligned is prepared. As illustrated in FIG. 15, the control unit 3 controls the display of the red subpixel R, the green subpixel G, and the blue subpixel B observed from a predetermined viewpoint through the opening portion 24 among combinations of the red subpixels R, the green subpixels G, and the blue subpixels B numbered from “1” to “18” and shifted by one subpixel in the first direction and the second direction, in accordance with an image from the viewpoint.

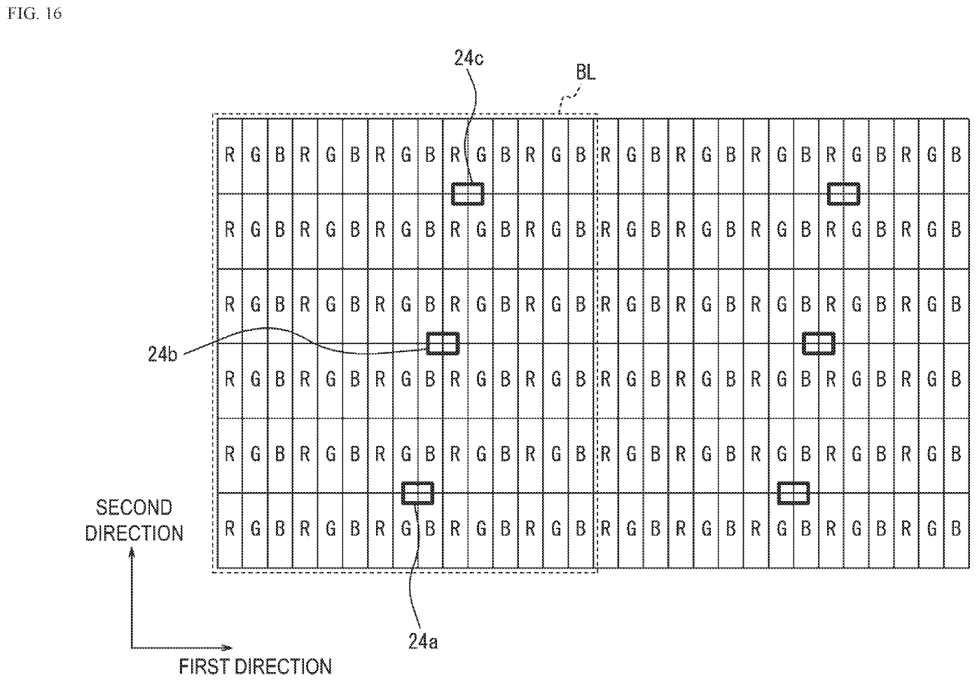

FIG. 16 is a diagram illustrating still another example of the positional relation between the pixel configuration of the image display unit 2 and the opening portion 24 provided in the barrier 23.

FIG. 16 illustrates an example in which three opening portions 24 (opening portions 24a, 24b, and 24c) are disposed in a pixel block BL of 6×6. The opening portion 24a is disposed in the vicinity of the center of the pixel block BL in the first direction, across the pixels px of two rows on the front side in the second direction, and across the green subpixel G and the blue subpixel B. The opening portion 24b is disposed in the vicinity of the center of the pixel block BL in the first direction, across the pixels px of two rows on the back side in the second direction with respect to the pixels px of two rows corresponding to the opening portion 24a, and across the blue subpixel B and the red subpixel R. The opening portion 24c is disposed in the vicinity of the center of the pixel block BL in the first direction, across the pixels px of two rows on the back side in the second direction with respect to the pixels px of two rows corresponding to the opening portion 24b, and across the red subpixel R and the green subpixel G. Also in FIG. 16, the width of the opening portion 24 in the first direction substantially equal to the width of the subpixel in the first direction. The plurality of opening portions 24 are disposed to be shifted in the first direction.

According to the image display unit 2 illustrated in FIG. 16, similarly to the image display unit 2 illustrated in FIG. 14, 18 viewpoints can be set in the first direction. Furthermore, in the image display unit 2 illustrated in FIG. 16, one opening portion 24 is disposed corresponding to the pixels px of two rows. Thus, as the observation position moves in the second direction, the pixel px observed through the opening portion 24 is switched between the upper pixel px and the lower pixel px. Thus, according to the image display unit 2 illustrated in FIG. 16, it is possible to set two viewing regions in the second direction.

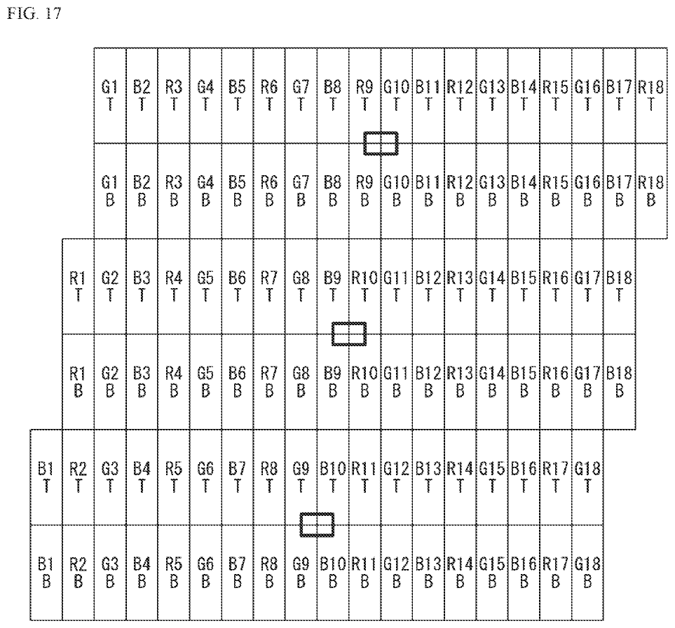

FIG. 17 is a diagram for explaining the display method in the display device 1 including the image display unit 2 illustrated in FIG. 16.

As described above, the image display unit 2 illustrated in FIG. 16 can set 18 viewpoints in the first direction and two viewing regions in the second direction. In this case, for each of the 18 viewpoints, in maximum, aligned in the direction along the first direction in which the subpixels having different colors are aligned, a directional image obtained by viewing a target from a certain observation position in the two viewing regions, that is, 36 directional images are prepared.

The control unit 3 controls the display of the subpixel observed when viewed from a predetermined observation position (set viewpoint and set viewing region) through the opening portion 24, in accordance with an image from the predetermined observation position. Specifically, as illustrated in FIG. 17, the control unit 3 controls the display of the red subpixel R, the green subpixel G, and the blue subpixel B observed from a predetermined viewpoint through the opening portion 24 among combinations of the red subpixels R, the green subpixels G, and the blue subpixels B numbered from “1” to “18”, in accordance with an image from the viewpoint. Here, the control unit 3 controls the display of the red subpixel R, the green subpixel G, and the blue subpixel B to which “T” is attached among the red subpixels R, the green subpixels G, and the blue subpixels B having the number corresponding to the viewpoint, in accordance with the directional image obtained by viewing a target from the lower side among directional images from a certain viewpoint. In addition, the control unit 3 controls the display of the red subpixel R, the green subpixel G, and the blue subpixel B to which “B” is attached among the red subpixels R, the green subpixels G, and the blue subpixels B having the number corresponding to the viewpoint, in accordance with the directional image obtained by viewing a target from the upper side among directional images from a certain viewpoint.

Thus, for example, the control unit 3 controls the display of the red subpixel R1B, the green subpixel G1B, and the blue subpixel B1B, in accordance with an image from a predetermined observation position which is a viewpoint on the rightmost side and is included in the viewing region on the upper side. In addition, for example, the control unit 3 controls the display of the red subpixel R18T, the green subpixel G18T, and the blue subpixel B18T, in accordance with an image from a predetermined observation position which is a viewpoint on the leftmost side and is included in the viewing region on the lower side.

As described above, according to the display device 1 including the image display unit 2 illustrated in FIG. 16, it is possible to cause an image corresponding to each observation position to be observed from 18 viewpoints in the first direction and from two viewing regions in the second direction.

The viewing region in the second direction is not limited to two.

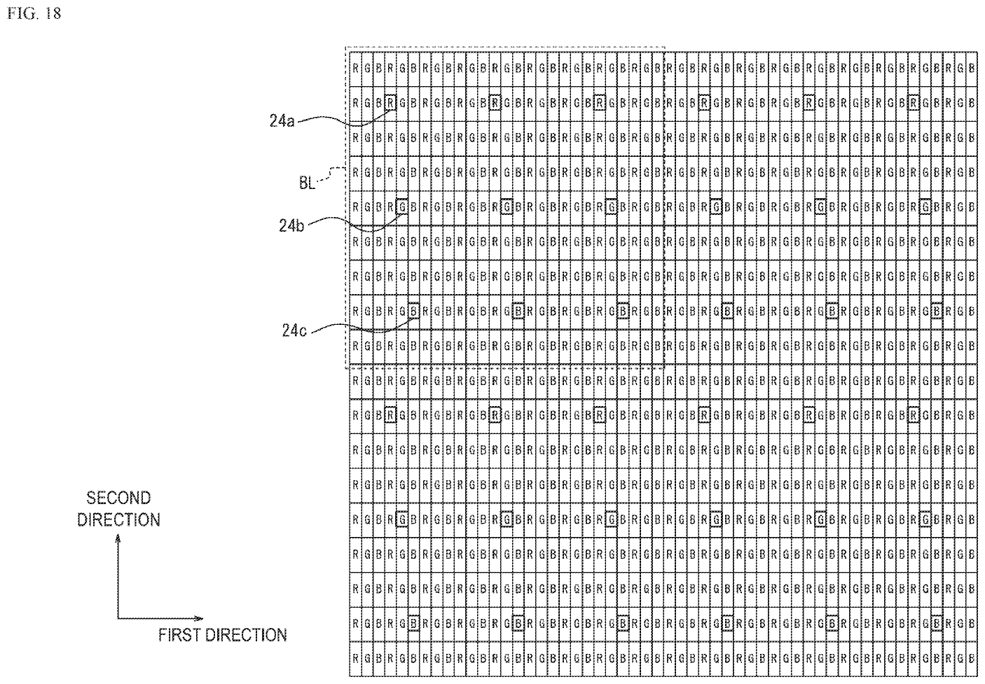

FIG. 18 is a diagram illustrating still another example of the positional relation between the pixel configuration of the image display unit 2 and the opening portion 24 provided in the barrier 23.

FIG. 18 illustrates an example in which 9 opening portions 24 (opening portions 24a, 24b, 24c, . . . ) are disposed in a pixel block BL of 9×9. The opening portion 24a is disposed on the red subpixel R of the pixel px in the middle row among the pixels px of the three rows on the back side in the second direction. The opening portion 24b is disposed on the green subpixel G of the pixel px in the middle row among the pixels px of the three rows on the front side in the second direction with respect to the pixels px of the three rows corresponding to the opening portion 24a. The opening portion 24c is disposed on the blue subpixel B of the pixel px in the middle row among the pixels px of the three rows on the front side in the second direction with respect to the pixels px of the three rows corresponding to the opening portion 24b. The opening portions 24a, 24b, and 24c are disposed every three pixels in the first direction. That is, the opening portions 24 aligned in the first direction are disposed at regular intervals. Also in FIG. 18, the width of the opening portion 24 in the first direction substantially equal to the width of the subpixel in the first direction. The plurality of opening portions 24 are disposed to be shifted in the first direction.

According to the image display unit 2 illustrated in FIG. 18, it is possible to set 9 viewpoints in the first direction. Furthermore, in the image display unit 2 illustrated in FIG. 18, one opening portion 24 is disposed corresponding to the pixels px of three rows. Thus, as the observation position moves in the second direction, the pixel px observed through the opening portion 24 is switched between the upper pixel px, the middle pixel px, and the lower pixel px. Thus, according to the image display unit 2 illustrated in FIG. 18, it is possible to set three viewing regions in the second direction.

The technique disclosed in PTL 3 does not allow a plurality of viewing regions to be set because the opening portion extends in the perpendicular direction (second direction in the present disclosure). On the other hand, in the present embodiment, it is possible to set a plurality of viewing regions by disposing one opening portion 24 corresponding to the pixels px of a plurality of rows.

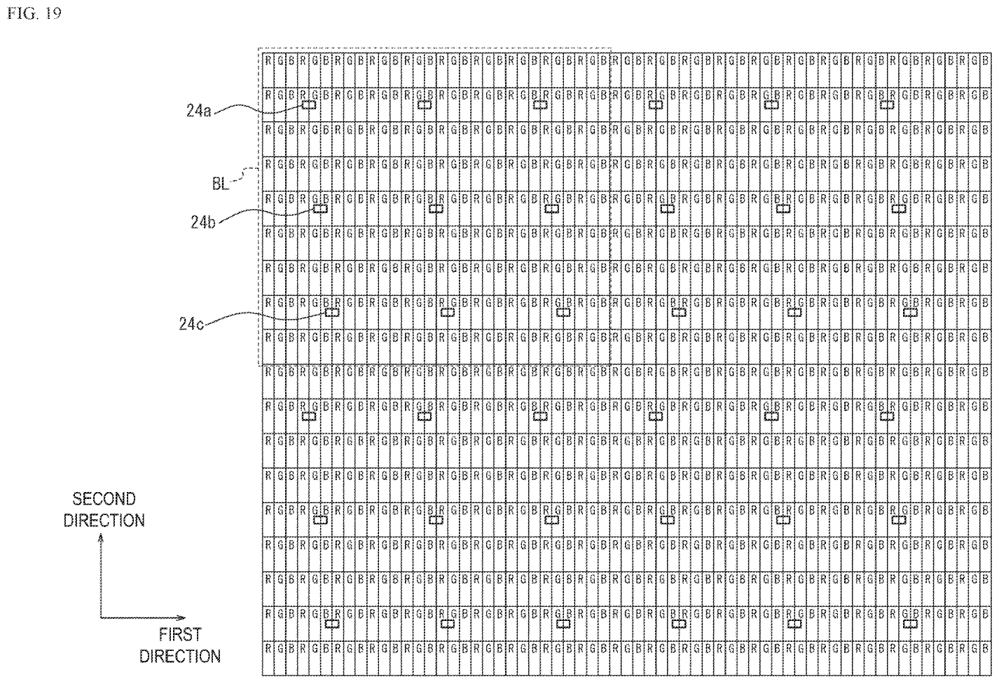

In FIG. 18, an example in which all the plurality of opening portions 24 aligned in the first direction are disposed on the subpixels having the same color is described, but the present disclosure is not limited thereto. As illustrated in FIG. 19, the plurality of opening portions 24 aligned in the first direction may be disposed across subpixels having different colors, respectively. In the image display unit 2 illustrated in FIG. 19, nine opening portions 24 are disposed in a pixel block BL of 10×9. Each opening portion 24 is disposed across two subpixels having different colors. Also in FIG. 19, the width of the opening portion 24 in the first direction substantially equal to the width of the subpixel in the first direction. The plurality of opening portions 24 are disposed to be shifted in the first direction. The plurality of opening portions 24 aligned in the first direction are disposed at regular intervals.

In the display device 1 including the image display unit 2 illustrated in FIG. 19, it is possible to set 10 viewpoints in the first direction, and three viewing regions in the second direction.

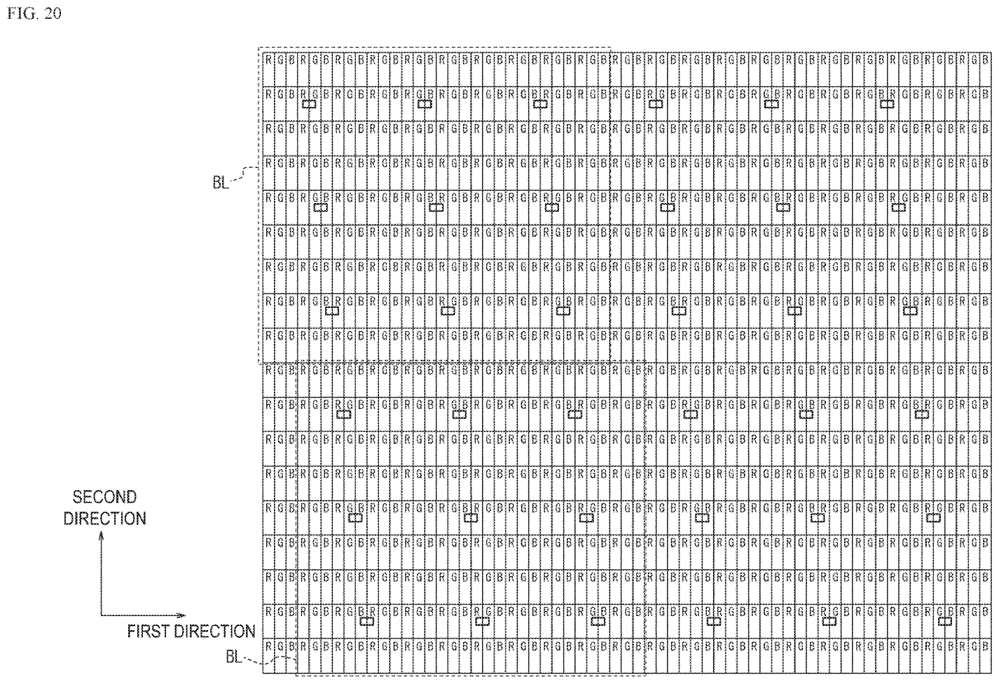

As illustrated in FIG. 20, the adjacent pixel blocks BL in the second direction may be disposed to be shifted in the first direction.

In the present embodiment, the image display unit 2 is described by using an example in which subpixels having a plurality of colors have a stripe structure in which subpixels having different colors are aligned in the first direction and subpixels having the same color are aligned in the second direction, but the present disclosure is not limited thereto.

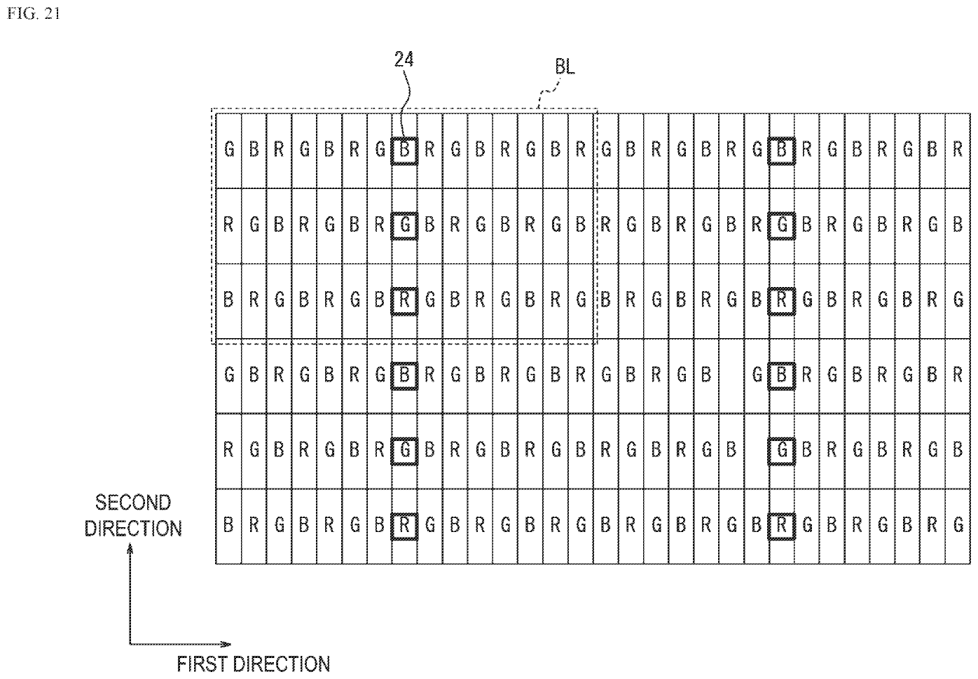

FIG. 21 is a diagram illustrating still another example of the positional relation between the pixel configuration of the image display unit 2 and the opening portion 24 provided in the barrier 23.

As illustrated in FIG. 21, the image display unit 2 may have a pixel structure in which subpixels having a plurality of colors are aligned so that colors of the adjacent subpixels in the first direction and the second direction perpendicular to the first direction are different from each other. In FIG. 21, three opening portions 24 are disposed in a pixel block BL of 5×3. The image display unit 2 illustrated in FIG. 21 causes the observer ob to observe an image through the plurality of opening portions 24 disposed for each pixel block BL. The width of the opening portion 24 in the first direction is substantially equal to the width of the subpixel in the first direction. The plurality of opening portions 24 are disposed at the same position in the first direction.

As described above, the image display unit 2 illustrated in FIG. 21 has a structure in which the subpixels having the plurality of colors are aligned so that the colors of the adjacent subpixels in the first direction and the second direction are different from each other. Thus, when viewed from a certain viewpoint, subpixels having different colors are observed from the three opening portions 24.

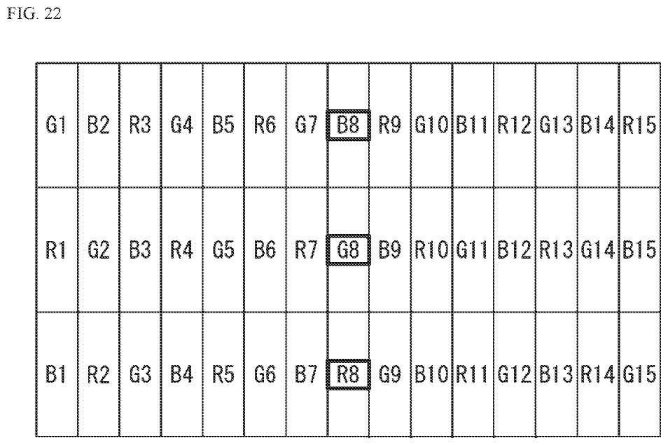

As illustrated in FIG. 22, the control unit 3 controls the display of three subpixels (red subpixel R, green subpixel G, and blue subpixel B numbered from “1” to “15”) that are aligned in the second direction and observed from a predetermined observation position (certain viewpoint) through the opening portion 24, in accordance with an image from the viewpoint. Specifically, as illustrated in FIG. 22, the control unit 3 controls the display of the red subpixel R, the green subpixel G, and the blue subpixel B observed from a predetermined viewpoint through the opening portion 24 among combinations of the red subpixels R, the green subpixels G, and the blue subpixels B that are numbered from “1” to “15” and continuous in the second direction, in accordance with an image from the viewpoint. Thus, also in the display device 1 including the image display unit 2 illustrated in FIG. 21, it is possible to increase the number of viewpoints from which an image in which the motion parallax is reproduced can be observed, and to make an expression with a high sense of realism.

In the present embodiment, the opening portion 24 is described by using an example in which the opening portion is a rectangle in which the width in the second direction is smaller than the width in the second direction of the subpixel, but the present disclosure is not limited thereto. In short, the opening portion 24 has a constant width in the second direction at any position in the first direction. In this manner, it is possible to linearly change the areas of the subpixels having the plurality of colors, which are observed at each observation position, in accordance with the movement of the observation position along the first direction.

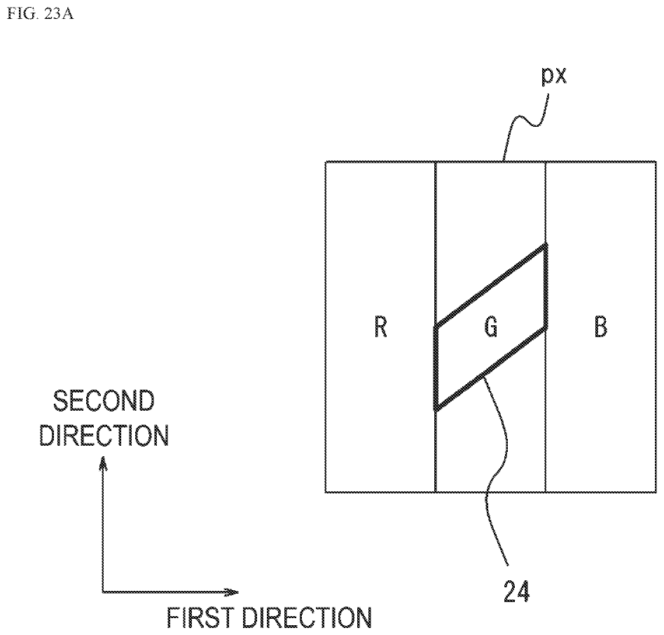

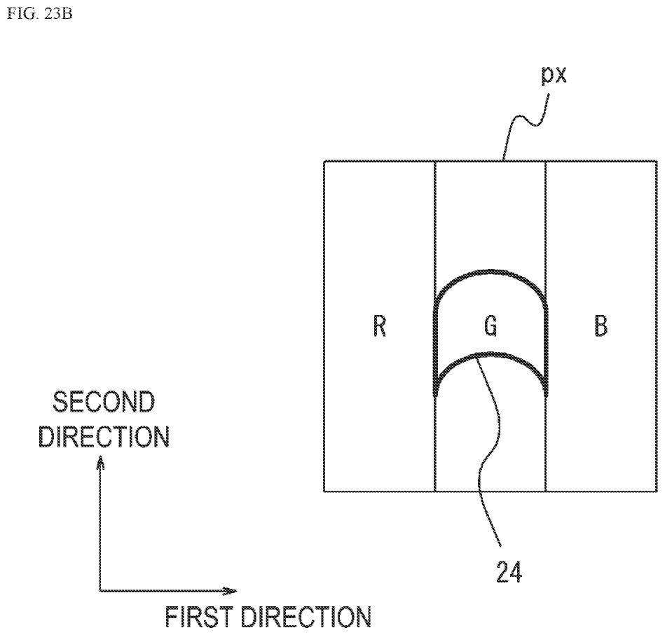

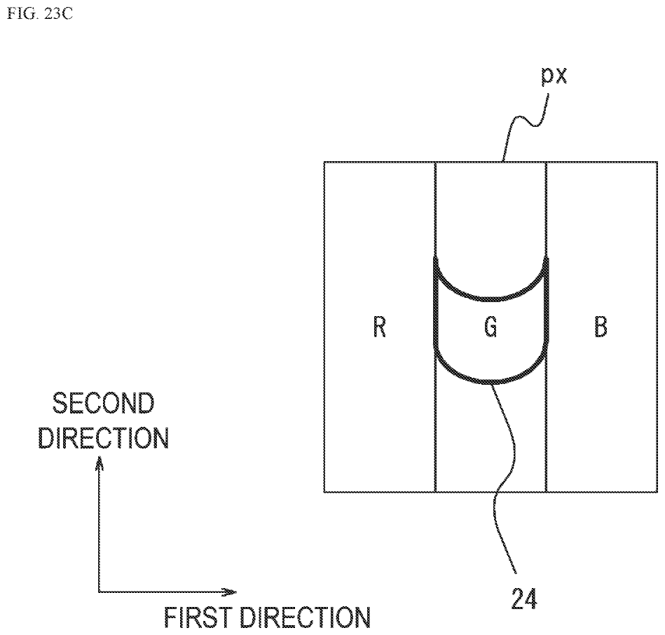

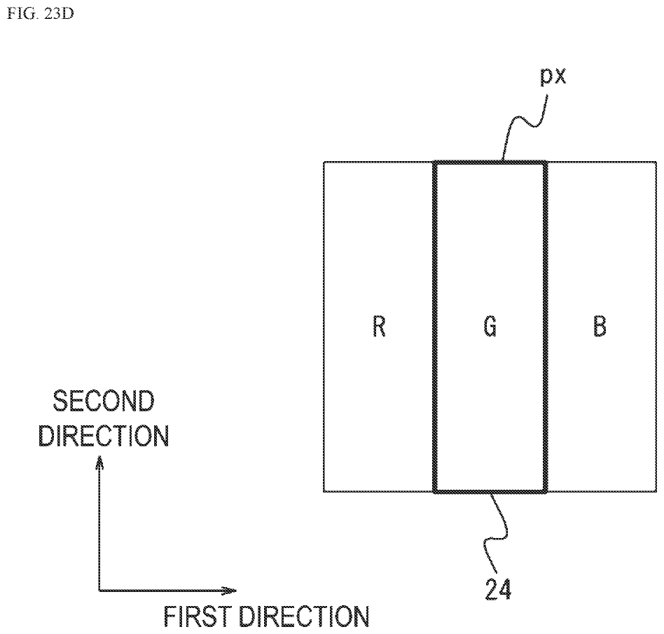

Thus, the shape of the opening portion 24 may be a parallelogram, as illustrated in FIG. 23A. As illustrated in FIG. 23B, the shape of the opening portion 24 may be a shape formed by two sides parallel to the second direction and two convex curves toward the back side in the second direction. As illustrated in FIG. 23C, the shape of the opening portion 24 may be a shape formed by two sides parallel to the second direction and two convex curves toward the front side in the second direction. As illustrated in FIG. 23D, the shape of the opening portion 24 may be a rectangle in which the width in the second direction is equal to the width of the subpixel in the second direction. In any opening portion 24 illustrated in FIGS. 23A, 23B, 23C, and 23D, the width in the first direction is substantially equal to the width of the subpixel in the first direction. For example, the opening portion 24 may be formed by two parallelogram-shaped openings shifted in the second direction. In this case, the width of the opening portion 24 in the second direction is the sum of the lengths of line segments obtained by the opening portion 24 cutting any straight line that is parallel to the second direction and passes through two parallelogram-shaped openings.

In the above-described embodiment, an example in which the pixel px has a square shape and is configured by three subpixels (red subpixel R, green subpixel G, and blue subpixel B) in which the width in the first direction is one-third of dp and the width in the second direction is dp is described, but the present disclosure is not limited thereto.

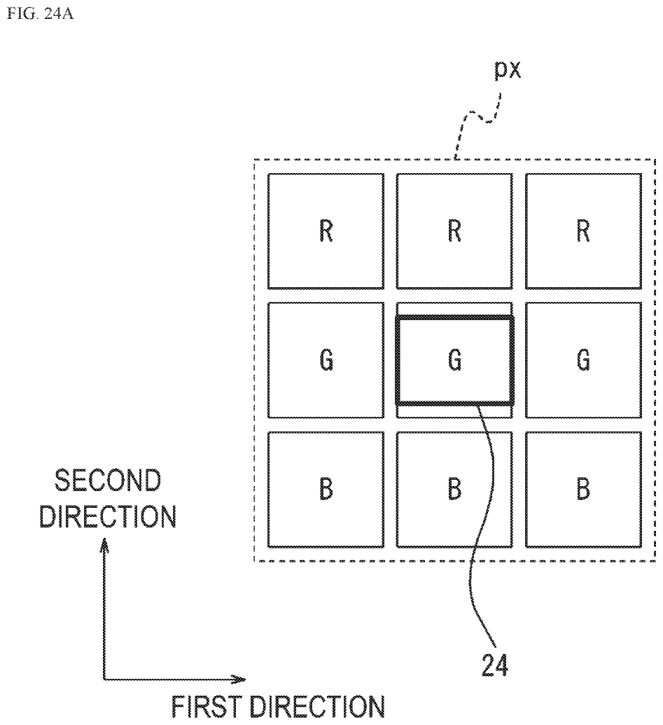

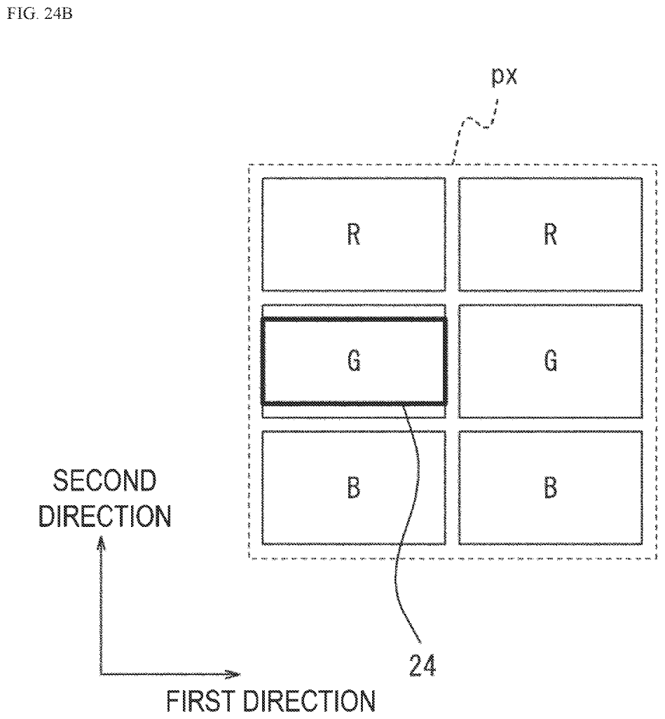

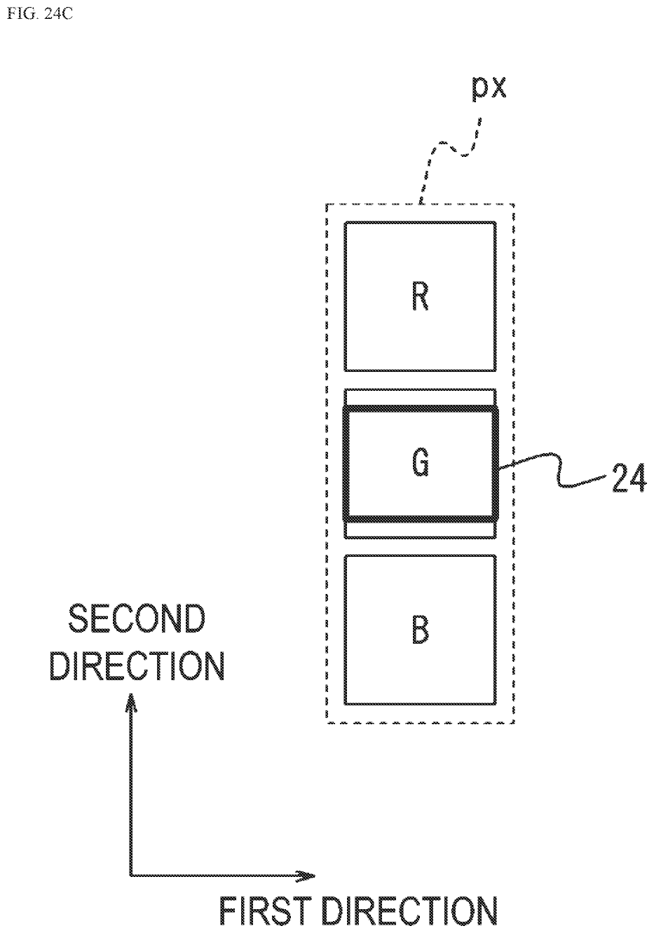

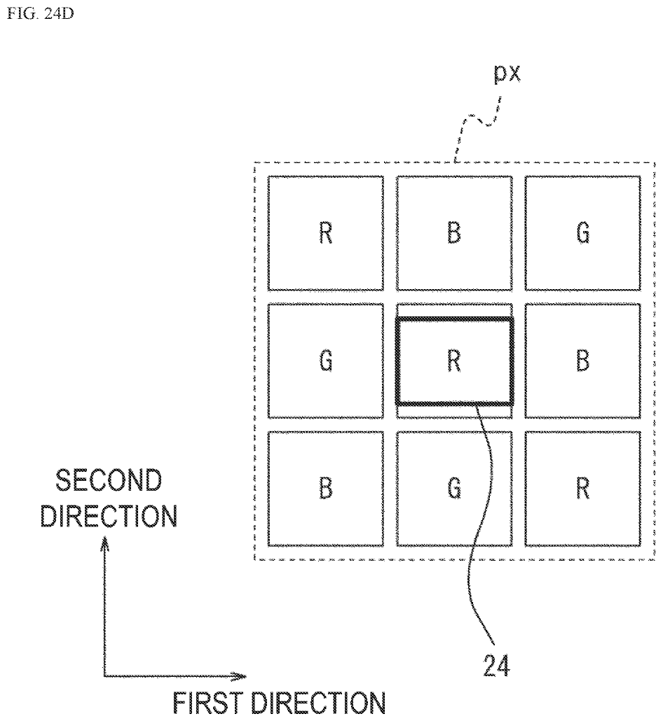

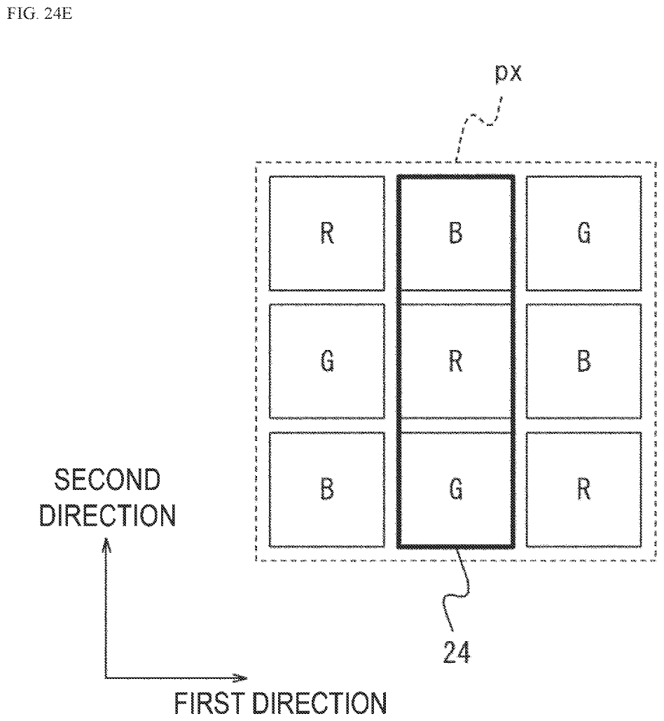

For example, as illustrated in FIG. 24A, the pixel px may have a configuration in which three blue subpixels B aligned in the first direction, three green subpixels G aligned in the first direction, and three red subpixels R aligned in the first direction are aligned in this order in the second direction. In this case, the width of the opening portion 24 in the first direction is substantially equal to the width of one subpixel in the first direction.

As illustrated in FIG. 24B, the pixel px may have a configuration in which two blue subpixels B aligned in the first direction, two green subpixels G aligned in the first direction, and two red subpixels R aligned in the first direction are aligned in this order in the second direction. In this case, the width of the opening portion 24 in the first direction is substantially equal to the width of one subpixel in the first direction.

As illustrated in FIG. 24C, the pixel px may have a shape in which the blue subpixel B, the green subpixel G, and the red subpixel R are aligned in this order in the second direction, and which is elongated in the second direction. In this case, the width of the opening portion 24 in the first direction is substantially equal to the width of one subpixel in the first direction.

As illustrated in FIG. 24D, the pixel px may have a square shape, and may have a configuration in which a plurality of red subpixels R, a plurality of green subpixels B, and a plurality of blue subpixels B are disposed so that colors of the adjacent subpixels in the first direction and the second direction are different from each other. In this case, the width of the opening portion 24 in the first direction is substantially equal to the width of one subpixel in the first direction. The width of the opening portion 24 in the second direction may be smaller than the width of one subpixel in the second direction as illustrated in FIG. 24D or may be equal to the width of the pixel px in the second direction as illustrated in FIG. 24E. In this case, the opening portions 24 corresponding to the pixels px adjacent in the second direction may be connected to form a stripe-shaped opening portion.

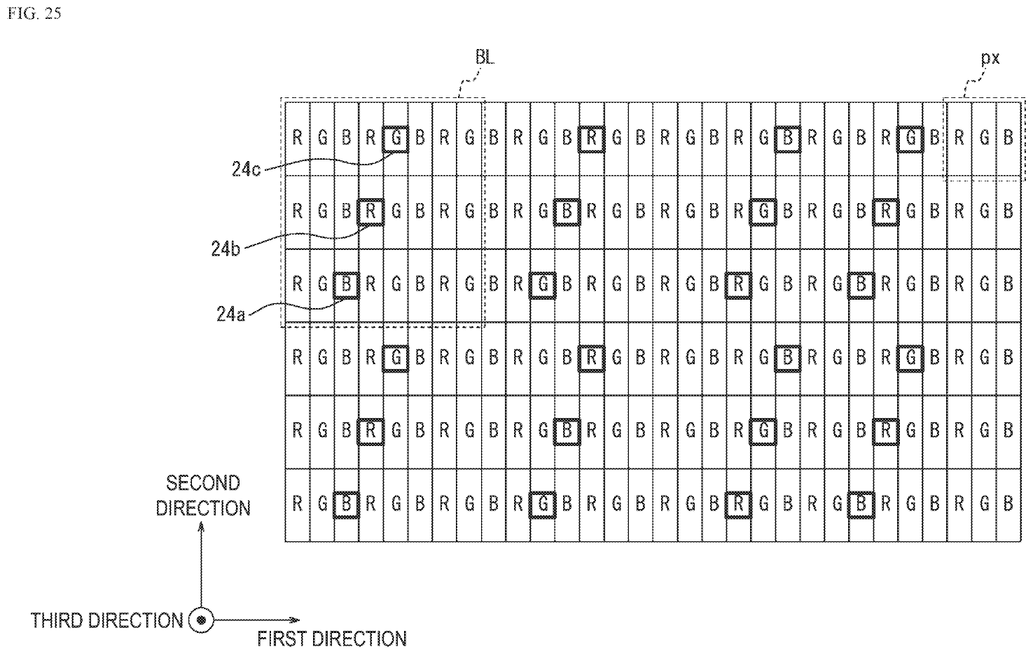

Furthermore, in the above-described embodiment, the pixel block BL is described by using an example of being configured in units of pixels, but the present disclosure is not limited thereto. For example, as illustrated in FIG. 25, three opening portions (opening portions 24a, 24b, and 24c) may be provided in a pixel block of 8/3×3. That is, in the first direction, the opening portions 24a, 24b, and 24c are provided for every 8 subpixels. In this case, the opening portions 24 adjacent in the first direction may be provided on subpixels having different colors.

In addition, one pixel px is described by using an example of being configured by three subpixels (red subpixel R, green subpixel G, and blue subpixel B), but the present disclosure is not limited thereto. For example, four colors of red, green, blue, and white may be used.

As described above, in the present embodiment, the display device 1 includes the image display unit 2 in which the subpixels having the plurality of colors have the pixel structure in which the subpixels having different colors are aligned in the first direction and the subpixels having the same color are aligned in the second direction, and the observer ob observes an image through the plurality of opening portions 24 disposed for each pixel block BL. The width of each of the plurality of opening portions 24 in the first direction is substantially equal to the width of the subpixel in the first direction. The plurality of opening portions 24 are disposed to be shifted in the first direction.

Since, in the above-described pixel configuration, the plurality of opening portions 24 in which the width in the first direction is substantially equal to the width of the subpixel in the first direction are disposed to be shifted in the first direction, it is possible to set the viewpoint every time the observation position in the first direction moves to an extent that the subpixels observed through the plurality of opening portions 24 are shifted by one subpixel. Thus, it is possible to increase the number of viewpoints from which an image in which motion parallax is reproduced can be observed, and to make an expression with a high sense of realism.

In addition, in the present embodiment, the display device 1 includes the image display unit 2 that has a pixel structure in which subpixels having a plurality of colors are aligned so that colors of adjacent subpixels in the first direction and the second direction are different from each other, and causes the observer ob to observe an image through a plurality of opening portions disposed for each pixel block BL. The width of each of the plurality of opening portions 24 in the first direction is substantially equal to the width of the subpixel in the first direction. The plurality of opening portions 24 are disposed at the same position in the first direction.

Since, in the above-described pixel configuration, the plurality of opening portions 24 in which the width in the first direction is substantially equal to the width of the subpixel in the first direction are disposed at the same position in the first direction, it is possible to set the viewpoint every time the observation position in the first horizontal direction moves to an extent that the subpixels observed through the plurality of opening portions 24 are shifted by one subpixel. Thus, it is possible to increase the number of viewpoints from which an image in which motion parallax is reproduced can be observed, and to make an expression with a high sense of realism.

The present disclosure is not limited to the configuration specified in the above-described embodiment, and various modifications can be made without departing from the gist of the invention described in the claims. For example, the functions and the like included in each of the components and the like can be realigned so as to not be logically inconsistent and a plurality of components and the like can be combined into one or divided.

### REFERENCE SIGNS LIST

1 . . . Image display device
2 . . . Image display unit
3 . . . Control unit
4 . . . Capturing target
5 . . . Camera
21 . . . Backlight
22 . . . Two-dimensional light modulation element
23 . . . Barrier
24, 24a, 24b, 24c, 24l, 24m, 24r . . . Opening portion
24a . . . Central portion
24b . . . First peripheral edge
24c . . . Second peripheral edge
25, 25a, 25b, 25c, 26a, 26b, 26c, 26d, 26e, 26f . . . Opening
ob . . . Observer
px, pklu, pxl, pxlb, pxu, px0, pxb, pxru, pxr, pxrb, px1 to px10 . . . Pixel
BL . . . Pixel block

1. A display device comprising:
an image display unit having a pixel structure of subpixels having a plurality of colors, in which the subpixels having different colors are aligned in a first direction, and the subpixels having an identical color are aligned in a second direction perpendicular to the first direction, the image display unit configured to cause an observer to observe an image through a plurality of opening portions disposed for an individual pixel block including a plurality of pixels including the subpixels having the plurality of colors, wherein
a width of each of the plurality of opening portions in the first direction is substantially equal to a width of a subpixel of the subpixels in the first direction, and
the plurality of opening portions are disposed to be shifted in the first direction.

2. The display device according to claim 1, wherein
a width of an opening portion of the plurality of opening portions in the second direction at any position of the opening portion in the first direction is constant.

3. The display device according to claim 1, wherein
a plurality of the opening portions aligned in the first direction are disposed at regular intervals.

4. The display device according to claim 1, wherein
areas of the subpixels having the plurality of colors, which are observed from any observation position through the plurality of opening portions, are equal to one another.

5. A display device comprising:
an image display unit having a pixel structure in which subpixels having a plurality of colors are aligned so that adjacent subpixels of the subpixels in a first direction have different colors and adjacent subpixels of the subpixels in a second direction perpendicular to the first direction have different colors, the image display unit configured to cause an observer to observe an image through a plurality of opening portions disposed for an individual pixel block including a plurality of pixels including the subpixels having the plurality of colors, wherein
a width of each of the plurality of opening portions in the first direction is substantially equal to a width of a subpixel of the subpixels in the first direction, and
the plurality of opening portions are disposed at an identical position in the first direction.

6. The display device according to claim 1, wherein
the individual pixel block includes at least the plurality of pixels of which the number is equal to the number of colors of the subpixels continuously aligned in the second direction, and
the plurality of opening portions is disposed corresponding one-to-one to the plurality of pixels of which the number is equal to the number of colors of the subpixels continuously aligned in the second direction.

7. The display device according to claim 1, wherein
adjacent pixel blocks of a plurality of the individual pixel blocks in the second direction are disposed to be shifted in the first direction.

8. A display method in a display device including an image display unit having a pixel structure of subpixels having a plurality of colors, in which the subpixels having different colors are aligned in a first direction, and the subpixels having an identical color are aligned in a second direction perpendicular to the first direction, the display method configured to cause an observer to observe an image through a plurality of opening portions disposed for an individual pixel block including a plurality of pixels including the subpixels having the plurality of colors,
a width of each of the plurality of opening portions in the first direction being substantially equal to a width of a subpixel of the subpixels in the first direction, and
the plurality of opening portions being disposed to be shifted in the first direction,
the display method comprising
controlling display of the subpixels observed when viewed from a predetermined observation position through the opening portion in accordance with an image from the predetermined observation position.
